(19) United States
(12) Patent Application Publication
(10) Pub. No.: US 2025/0159526 A1
(43) Pub. Date: May 15, 2025

(54) INFORMATION CONFIGURATION METHOD, APPARATUS, DEVICE, AND STORAGE MEDIUM

(71) Applicant: Beijing Xiaomi Mobile Software Co., Ltd., Beijing (CN)

(72) Inventor: Yi XIONG, Beijing (CN)

(21) Appl. No.: 18/836,080

(22) PCT Filed: Feb. 11, 2022
(86) PCT No.: PCT/CN2022/076105

§ 371 Date: Aug. 6, 2024

(51) Int. Cl. H04W 24/10; H04W 56/00; H04W 84/06

(52) U.S. Cl. CPC H04W 24/10; H04W 56/0015; H04W 84/06

(57) ABSTRACT

An information configuration method is performed by user equipment (UE), and includes: determining, based on a configuration of a network-side device, at least one of at least one available measurement gap configuration or an association between each available measurement gap configuration and one or more specific to-be-measured parameters for indication.

### CROSS-REFERENCE TO RELATED APPLICATION

This application is the U.S. national phase application of International Application No. PCT/CN2022/076105, filed on Feb. 11, 2022, the disclosure of which is incorporated herein by reference in its entirety.

### TECHNICAL FIELD

The present disclosure relates to the field of communication technologies, and in particular, to an information configuration method, apparatus, device, and a storage medium.

### BACKGROUND

In a non-terrestrial network (NTN) system, user equipment (UE) usually needs to measure neighboring cells. However, different to-be-measured neighboring cells may correspond to different satellites in the NTN system. Due to different distances between different satellites and the UE, there may be relatively large transmission delay when the UE receives signals from the different to-be-measured neighboring cells. Therefore, it is required to introduce a plurality of different measurement gap configurations, so as to adapt to measuring the signals of different to-be-measured cells.

In related arts, a plurality of parallel measurement gap configurations are directly configured for the UE. However, when configuring the plurality of parallel measurement gap configurations for the UE in the related arts, configuring up to only two measurement gap configurations of the same type can be supported. The fewer configurable measurement gap configurations are not suitable for measuring a plurality of different to-be-measured cells. In addition, the method that “a plurality of parallel measurement gap configurations are directly configured” in the related arts causes large signaling overhead. Besides that, since one or more cells corresponding to each satellite rapidly move due to rapid movement of the satellite, transmission delay difference between various cells changes in real time and thus the measurement gap configurations need to be updated at any time (that is, the plurality of parallel measurement gap configurations need to be updated and configured continuously), which further increases the signaling overhead.

### SUMMARY

The present disclosure provides information configuration methods, apparatuses, devices, and storage media.

Examples in one aspect of the present disclosure provide an information configuration method, which is performed by UE and includes: determining, based on a configuration of a network-side device, at least one of: at least one available measurement gap configuration or an association between each available measurement gap configuration and one or more specific to-be-measured parameters for indication.

Examples in another aspect of the present disclosure provide an information configuration method, which is performed by a network-side device and includes: configuring for UE at least one of: at least one available measurement gap configuration or an association between each available measurement gap configuration and/or one or more specific to-be-measured parameters for indication.

Examples in another aspect of the present disclosure provide a communication device, which includes a processor and a memory, wherein a computer program stored in the memory is executed by the processor to enable the device to perform: determining, based on a configuration of a network-side device, at least one of: at least one available measurement gap configuration or an association between each available measurement gap configuration and one or more specific to-be-measured parameters for indication.

### BRIEF DESCRIPTION OF DRAWINGS

The above and/or additional aspects and advantages of the present disclosure will become apparent and readily understood according to the following description of the examples in conjunction with the accompanying drawings.

FIG. 1 is a schematic flowchart of an information configuration method provided by an example of the present disclosure.

FIG. 2 is a schematic flowchart of an information configuration method provided by another example of the present disclosure.

FIG. 3 is a schematic flowchart of an information configuration method provided by another example of the present disclosure.

FIG. 4 is a schematic flowchart of an information configuration method provided by another example of the present disclosure.

FIG. 5 is a schematic flowchart of an information configuration method provided by another example of the present disclosure.

FIG. 6 is a schematic flowchart of an information configuration method provided by another example of the present disclosure.

FIG. 7 is a schematic flowchart of an information configuration method provided by another example of the present disclosure.

FIG. 8a is a schematic flowchart of an information configuration method provided by another example of the present disclosure.

FIG. 8b is a schematic flowchart of an information configuration method provided by another example of the present disclosure.

FIG. 9 is a schematic flowchart of an information configuration method provided by another example of the present disclosure.

FIG. 10 is a schematic flowchart of an information configuration method provided by another example of the present disclosure.

FIG. 11 is a schematic flowchart of an information configuration method provided by another example of the present disclosure.

FIG. 12 is a schematic flowchart of an information configuration method provided by another example of the present disclosure.

FIG. 13 is a schematic flowchart of an information configuration method provided by another example of the present disclosure.

FIG. 14 is a schematic flowchart of an information configuration method provided by another example of the present disclosure.

FIG. 15 is a schematic flowchart of an information configuration method provided by another example of the present disclosure.

FIG. 16a is a schematic flowchart of an information configuration method provided by another example of the present disclosure.

FIG. 16b is a schematic flowchart of an information configuration method provided by another example of the present disclosure.

FIG. 17 is a schematic structure diagram of an information configuration apparatus provided by an example of the present disclosure.

FIG. 18 is a schematic structure diagram of an information configuration apparatus provided by another example of the present disclosure.

FIG. 19 is a block diagram of UE provided by an example of the present disclosure.

FIG. 20 is a block diagram of a network-side device provided by an example of the present disclosure.

### DETAILED DESCRIPTION

Embodiments will be described in detail here with the examples thereof illustrated in the drawings. Where the following descriptions involve the drawings, like numerals in different drawings refer to like or similar elements unless otherwise indicated. The implementations described in the following examples do not represent all implementations consistent with the present disclosure. Rather, they are merely examples of apparatuses and methods consistent with some aspects of the present disclosure as detailed in the appended claims.

The terms used in the present disclosure are for the purpose of describing particular examples only, and are not intended to limit the examples of the present disclosure. Terms determined by “a” and “the” in their singular forms used in the examples of the present disclosure and the appended claims are also intended to include their plural forms, unless clearly indicated otherwise in the context. It is also to be understood that the term “and/or” as used herein is and includes any and all possible combinations of one or more of the associated listed items.

It is to be understood that, although terms “first,” “second,” “third,” and the like may be adopted in the examples of the present disclosure to describe various information, such information should not be limited to these terms. These terms are only used to distinguish the information of the same type with each other. For example, without departing from the scope of the examples of the present disclosure, first information may be referred as second information; and similarly, second information may also be referred as first information. Depending on the context, the word “if” as used herein may be interpreted as “when,” “upon,” or “in response to determining.”

The information configuration methods, apparatuses, devices and storage media provided by the examples of the present disclosure are described in detail with reference to the accompanying drawings below.

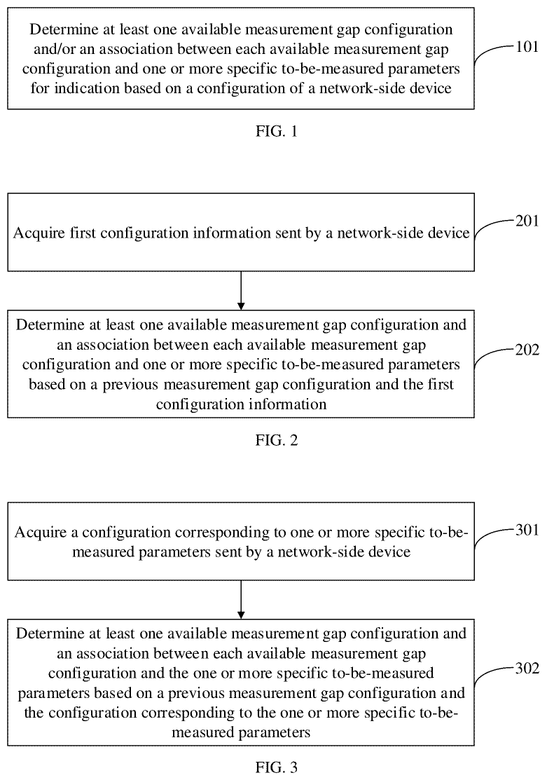

FIG. 1 is a schematic flowchart of an information configuration method provided by an example of the present disclosure. The method is performed by user equipment (UE). As illustrated in FIG. 1, the information configuration method may include the following step.

At step 101, at least one available measurement gap configuration and/or an association between each available measurement gap configuration and one or more specific to-be-measured parameters for indication are determined based on a configuration of a network-side device.

Specifically, in an example of the present disclosure, the UE may refer to a device that provides voice and/or data connectivity for a user. The terminal device may communicate with one or more core networks via a radio access network (RAN). The UE may be an Internet of Things terminal, such as a sensor device, a mobile phone (or called a “cellular” phone), and a computer equipped with the Internet of Things terminal, which may, for example, be a fixed, portable, pocket-sized, handheld, computer-built-in or vehicle-mounted device. For example, the UE may be a station (STA), a subscriber unit, a subscriber station, a mobile station, a mobile, a remote station, an access point, a remote terminal, an access terminal, a user terminal, or a user agent. Or, the UE may be a device like an unmanned drone. Or, the UE may be a vehicle-mounted device, which may, for example, be an on-board computer with a wireless communication function or a wireless terminal externally connected to the on-board computer. Or, the UE may be a roadside device, which may, for example, be a street lamp, a signal lamp or another roadside device with a wireless communication function.

In an example of the present disclosure, the specific to-be-measured parameters may include at least one of the following:
a measurement object;
a to-be-measured frequency;
a to-be-measured cell;
a to-be-measured satellite; or
a synchronization signal block measurement timing configuration (SMTC) configuration.

In an example of the present disclosure, the at least one available measurement gap configuration and the association between each available measurement gap configuration and the one or more specific to-be-measured parameters may be determined based on the configuration of the network-side device.

In another example of the present disclosure, only the at least one available measurement gap configuration may be determined based on the configuration of the network-side device.

The method of “determining the at least one available measurement gap configuration and the association between each available measurement gap configuration and the one or more specific to-be-measured parameters based on the configuration of the network-side device” mentioned above and the method of “determining only the at least one available measurement gap configuration based on the configuration of the network-side device” mentioned above are introduced in detail in subsequent examples.

In addition, it is to be noted that in an example of the present disclosure, the available measurement gap configuration may be a gap configuration per UE gap. In another example of the present disclosure, the available measurement gap configuration may be a gap configuration of per frequency range (FR).

In an example of the present disclosure, the gap configuration per FR includes a gap configuration for FR1 and a gap configuration for FR2.

In view of the above, in the information configuration method provided by the example of the present disclosure, based on the configuration of the network-side device, the UE determines the at least one available measurement gap configuration and/or the association between each available measurement gap configuration and the one or more specific to-be-measured parameters for indication, and subsequently one or more corresponding cells or frequency points can be measured based on the association and the at least one available measurement gap configuration. Specifically, in the example of the present disclosure, the UE determines the at least one available measurement gap configuration based on at least one measurement gap offset configured by the network-side device. It can be seen in the example of the present disclosure that a plurality of available measurement gap configurations can be obtained by configuring only a plurality of measurement gap offsets, resulting in low signaling overheads. Meanwhile, lager number of available measurement gap configurations can be obtained since there is no limit to the number of the configured measurement gap offsets, which can be suitable for measuring a plurality of different to-be-measured cells or frequency points.

FIG. 2 is a schematic flowchart of an information configuration method provided by an example of the present disclosure, which is performed by UE. The method illustrated in FIG. 2 is configured to determine at least one available measurement gap configuration and an association between each available measurement gap configuration and one or more specific to-be-measured parameters. As illustrated in FIG. 2, the information configuration method may include the following steps.

At step 201, first configuration information sent by a network-side device is acquired.

Specifically, in an example of the present disclosure, the first configuration information may include at least one measurement gap offset and the one or more specific to-be-measured parameters associated with each measurement gap offset, or may include at least one measurement gap offset identifier and the one or more specific to-be-measured parameters associated with each measurement gap offset identifier, or may include at least one measurement gap offset and the one or more identifiers of one or more specific to-be-measured parameters associated with each measurement gap offset, or may include at least one measurement gap offset identifier and the one or more identifiers of one or more specific to-be-measured parameters associated with each measurement gap offset identifier.

It is to be noted that in an example of the present disclosure, a plurality of measurement gap offsets may be sent in a list form when the first configuration information includes the plurality of measurement gap offsets.

In an example of the present disclosure, the specific to-be-measured parameters may include at least one of the following:
a measurement object;
a to-be-measured frequency;
a to-be-measured cell;
a to-be-measured satellite; or
a SMTC configuration.

It is to be noted that in an example of the present disclosure, there may be a one-to-one association between the measurement gap offsets and the specific to-be-measured parameters, that is, one measurement gap offset is associated with one specific to-be-measured parameter. In another example of the present disclosure, there may be a one-to-many association between the measurement gap offsets and the specific to-be-measured parameters, that is, one measurement gap offset is associated with a plurality of specific to-be-measured parameters, and the plurality of specific to-be-measured parameters may be represented in a list form. In another example of the present disclosure, there may be a many-to-one association between the measurement gap offsets and the specific to-be-measured parameters, that is, a plurality of measurement gap offsets are associated with one specific to-be-measured parameter, and the plurality of measurement gap offsets may be represented in a list form.

In an example of the present disclosure, the “association between the measurement gap offset identifiers and the specific to-be-measured parameters” is similar to the “association between the measurement gap offsets and the specific to-be-measured parameters”. Thus, there may be a one-to-one association between the measurement gap offset identifiers and the specific to-be-measured parameters, that is, one measurement gap offset identifier is associated with one specific to-be-measured parameter. In another example of the present disclosure, there may be a one-to-many association between the measurement gap offset identifiers and the specific to-be-measured parameters, that is, one measurement gap offset identifier is associated with a plurality of specific to-be-measured parameters, and the plurality of specific to-be-measured parameters may be represented in a list form. In another example of the present disclosure, there may be a many-to-one association between the measurement gap offset identifiers and the specific to-be-measured parameters, that is, a plurality of measurement gap offset identifiers are associated with one specific to-be-measured parameter, and the plurality of measurement gap offset identifiers may be represented in a list form.

Besides that, the “association between the measurement gap offset identifiers and the identifiers of the specific to-be-measured parameters” and the “associations between the measurement gap offsets and the identifiers of the specific to-be-measured parameters” are similar to the above-mentioned associations, and are not repeated in the examples of the present disclosure.

Furthermore, in an example of the present disclosure, the first configuration information may be configured in a configuration for a measurement gap, and the configuration for the measurement gap may include but is not limited to an information element (IE), a parameter, a radio resource control (RRC) message or a field like MeasConfig, MeasGapConfig, GapConfig, etc.

In an example of the present disclosure, the first configuration information may be configured in the configuration for the gap in the following implementation:

for a measurement gap offset, a measurement gap offset identifier, and a corresponding association, one or more of them are included in the first parameter.

Specifically, a plurality of first parameters may be included in a first list, and the first list may be included in the above configuration for the measurement gap.

Specifically, in an example of the present disclosure, the association in the first parameter may be one or one group of specific to-be-measured parameters or their identifiers corresponding to the measurement gap offset in the first parameter.

For example, in an example of the present disclosure, the association in the first parameter may be one or one group of measurement objects or their identifiers corresponding to the measurement gap offset in the first parameter.

Besides that, it is to be noted that in an example of the present disclosure, the one group of specific to-be-measured parameters or their identifiers may be represented by a list.

Furthermore, in an example of the present disclosure, the first list may be used for configuring the measurement gap offset configuration and configuring the corresponding association per UE or per FR.

At step 202, at least one available measurement gap configuration and an association between each available measurement gap configuration and one or more specific to-be-measured parameters are determined based on a previous measurement gap configuration and the first configuration information.

Specifically, in an example of the present disclosure, the previous measurement gap configuration may include but is not limited to one or more of a measurement gap length, a measurement gap period, a measurement gap timing advance, and a measurement gap offset.

In an example of the present disclosure, the method of determining the at least one available measurement gap configuration and the association between each available measurement gap configuration and the one or more specific to-be-measured parameters based on the previous measure gap configuration and the first configuration information may specifically include the following steps.

At step a, the at least one available measurement gap configuration is determined correspondingly based on the previous measurement gap configuration and different measurement gap offsets in the first configuration information.

Specifically, in an example of the present disclosure, various measurement gap offsets may be applied separately on the basis of the previous measurement gap configuration to obtain the at least one available measurement gap configuration.

It is to be noted that in an example of the present disclosure, when step a is performed, the at least one available measurement gap configuration may be obtained by applying different measurement gap offsets in the first configuration information and the previous measurement gap configuration in the previous measurement gap configuration on the basis of the measurement gap length, the measurement gap period, and the measurement gap timing advance of the previous measurement gap configuration.

For example, in an example of the present disclosure, it is assumed that the first configuration information includes two measurement gap offsets and the previous measurement gap configuration includes one measurement gap offset. In this case, three available measurement gap configurations may be obtained by applying the two measurement gap offsets included in the first configuration information and the one measurement gap offset included in the previous measurement gap configuration on the basis of the measurement gap length, the measurement gap period, and the measurement gap timing advance of the previous measurement gap configuration.

In another example of the present disclosure, when the step a is performed, the at least one available measurement gap configuration may be obtained by applying only the different measurement gap offsets in the first configuration information on the basis of the measurement gap length, the measurement gap period, and the measurement gap timing advance of the previous measurement gap configuration (that is, the measurement gap offset in the previous measurement gap configuration is ignored).

For example, in an example of the present disclosure, it is assumed that the first configuration information includes two measurement gap offsets and the previous measurement gap configuration includes one measurement gap offset. In this case, two available measurement gap configurations may be obtained by applying only the two measurement gap offsets included in the first configuration information on the basis of the measurement gap length, the measurement gap period, and the measurement gap timing advance of the previous measurement gap configuration.

At step b, the association between each available measurement gap configuration and the one or more specific to-be-measured parameters is determined based on the association in the first configuration information.

Specifically, in an example of the present disclosure, after the at least one available measurement gap configuration is determined correspondingly based on different measurement gap offsets, one or more specific to-be-measured parameters associated with a measurement gap offset may be determined as the to-be-measured parameters associated with the available measurement gap configuration corresponding to the measurement gap offset.

For example, in an example of the present disclosure, assuming that an available measurement gap configuration #1 is determined based on a measurement gap offset #1, in which the specific to-be-measured parameter associated with the measurement gap offset #1 is a to-be-measured cell #1, the specific to-be-measured parameter associated with the available measurement gap configuration #1 is determined as being the to-be-measured cell #1.

For example, in another example of the present disclosure, assuming that an available measurement gap configuration #1 is determined based on a measurement gap offset #1, in which the specific to-be-measured parameter associated with the measurement gap offset #1 is a to-be-measured object #1, the specific to-be-measured parameter associated with the available measurement gap configuration #1 is determined as being the to-be-measured object #1.

In view of the above, in the information configuration method provided by the example of the present disclosure, based on the configuration of the network-side device, the UE determines the at least one available measurement gap configuration and/or the association between each available measurement gap configuration and the one or more specific to-be-measured parameters for indication, and subsequently a corresponding cell or frequency point can be measured based on the association and the at least one available measurement gap configuration. Specifically, in the example of the present disclosure, the UE determines the at least one available measurement gap configuration based on at least one measurement gap offset configured by the network-side device. It can be seen in the example of the present disclosure that a plurality of available measurement gap configurations can be obtained by configuring only a plurality of measurement gap offsets, resulting in low signaling overheads. Meanwhile, lager number of available measurement gap configurations can be obtained since there is no limit to the number of the configured measurement gap offsets, which can be suitable for measuring a plurality of different to-be-measured cells or frequency points.

FIG. 3 is a schematic flowchart of an information configuration method provided by an example of the present disclosure, which is performed by UE. The method illustrated in FIG. 3 is configured to determine at least one available measurement gap configuration and an association between each available measurement gap configuration and one or more specific to-be-measured parameters. As illustrated in FIG. 3, the information configuration method may include the following steps.

At step 301, a configuration corresponding to one or more specific to-be-measured parameters sent by a network-side device and at least one measurement gap offset or measurement gap offset identifier sent by the network-side device are acquired.

Specifically, in an example of the present disclosure, the configuration corresponding to the one or more specific to-be-measured parameters may include an association between the one or more specific to-be-measured parameters and the measurement gap offset or the measurement gap offset identifier.

The detailed introductions of the “one or more specific to-be-measured parameters”, the “association between the one or more specific to-be-measured parameters and the measurement gap offset” and the “association between the one or more specific to-be-measured parameters and the measurement gap offset identifier” may make reference to the foregoing examples, and are not repeated in the example of the present disclosure.

In an example of the present disclosure, the measurement gap offset identifier or the measurement gap offset may be configured in a configuration for the measurement gap or a configuration for the one or more specific to-be-measured parameters associated therewith (such as GapConfig or MeasObjectNR) or in another configuration.

Furthermore, in an example of the present disclosure, for the association between each measurement gap offset identifier or measurement gap offset and the one or more specific to-be-measured parameters, it may be configured in the configuration for the one or more specific to-be-measured parameters (such as GapConfig or MeasObjectNR) or in another configuration.

In an example of the present disclosure, the measurement gap offset identifier may be configured in the configuration for the gap in the following implementation:
one or more of the measurement gap offset and the measurement gap offset identifier are included in a second parameter.

Specifically, a plurality of second parameters may be included in a second list, and the second list may be included in the above configuration for the gap.

In another example of the present disclosure, the measurement gap offset associated with the one or more specific to-be-measured parameters may be configured in the configuration for the one or more specific to-be-measured parameters in the following implementation:
a plurality of measurement gap offsets associated with the one or more specific to-be-measured parameters are included in a third list, and the third list is included in the configuration for the one or more specific to-be-measured parameters.

Alternatively, one measurement gap offset associated with the one or more specific to-be-measured parameters is included in the configuration for the one or more specific to-be-measured parameters.

In another example of the present disclosure, the measurement gap offset identifier associated with the one or more specific to-be-measured parameters may be configured in the configuration for the one or more specific to-be-measured parameters in the following implementation:
a plurality of measurement gap offset identifiers associated with the one or more specific to-be-measured parameters are included in a fourth list, and the fourth list is included in the configuration for the one or more specific to-be-measured parameters.

Alternatively, one measurement gap offset identifier associated with the one or more specific to-be-measured parameters is included in the configuration for the one or more specific to-be-measured parameters.

In another example of the present disclosure, when the SMTC configuration is taken as the one or more specific to-be-measured parameters, the measurement gap offset or measurement gap offset identifier associated with the SMTC may be configured in the configuration for the SMTC:
a plurality of measurement gap offsets or measurement gap offset identifiers associated with the SMTC are included in a fifth list, and one or more of the fifth list, a cell list corresponding to the SMTC and the parameters of the SMTC are included in the SMTC-related configuration.

Alternatively, one or more of one measurement gap offset or measurement gap offset identifier associated with the SMTC, the cell list corresponding to the SMTC and the parameters of the SMTC are included in the SMTC-related configuration.

For example, in an example of the present disclosure, the configuration for the SMTC may be included in a configuration for a measurement object.

Furthermore, other configuration methods regarding the measurement gap offset identifier or measurement gap offset are similar to the configuration method of the first configuration information in the above examples, and are not repeated in the example of the present disclosure.

At step 302, at least one available measurement gap configuration and an association between each available measurement gap configuration and the one or more specific to-be-measured parameters are determined based on a previous measurement gap configuration, the at least one measurement gap offset or measurement gap offset identifier and the configuration corresponding to the one or more specific to-be-measured parameters.

Specifically, in an example of the present disclosure, the previous measurement gap configuration may include but is not limited to one or more of a measurement gap length, a measurement gap period, a measurement gap timing advance, and a measurement gap offset.

In an example of the present disclosure, the method that the at least one available measurement gap configuration and the association between each available measurement gap configuration and the one or more specific to-be-measured parameters are determined based on the previous measurement gap configuration and the configuration corresponding to the one or more specific to-be-measured parameters may include the following steps.

At step c, the measurement gap offset associated with the one or more specific to-be-measured parameters is determined based on the configuration corresponding to the one or more specific to-be-measured parameters.

Specifically, in an example of the present disclosure, the measurement gap offset included in the configuration for the one or more specific to-be-measured parameters may be directly determined as the measurement gap offset associated with the one or more specific to-be-measured parameters. Alternatively, in another example of the present disclosure, the measurement gap offset corresponding to the measurement gap offset identifier included in the configuration corresponding to the one or more specific to-be-measured parameters may be directly determined as the measurement gap offset associated with the one or more specific to-be-measured parameters.

At Step d, the available measurement gap configuration associated with the one or more specific to-be-measured parameters is obtained by applying the measurement gap offset associated with the configuration corresponding to the one or more specific to-be-measured parameters on the basis of the previous measurement gap configuration.

The detailed method that “the available measurement gap configuration is obtained by applying the measurement gap offset on the basis of the previous measurement gap configuration” may make reference to the description of the above examples, and is not repeated in the example of the present disclosure.

In view of the above, in the information configuration method provided by the example of the present disclosure, based on the configuration of the network-side device, the UE determines the at least one available measurement gap configuration and/or the association between each available measurement gap configuration and the one or more specific to-be-measured parameters for indication, and subsequently a corresponding cell or frequency point can be measured based on the association and the at least one available measurement gap configuration. Specifically, in the example of the present disclosure, the UE determines the at least one available measurement gap configuration based on at least one measurement gap offset configured by the network-side device. It can be seen in the examples of the present disclosure that a plurality of available measurement gap configurations can be obtained by configuring only a plurality of measurement gap offsets, resulting in low signaling overheads. Meanwhile, lager number of available measurement gap configurations can be obtained since there is no limit to the number of the configured measurement gap offsets, which can be suitable for measuring a plurality of different to-be-measured cells or frequency points.

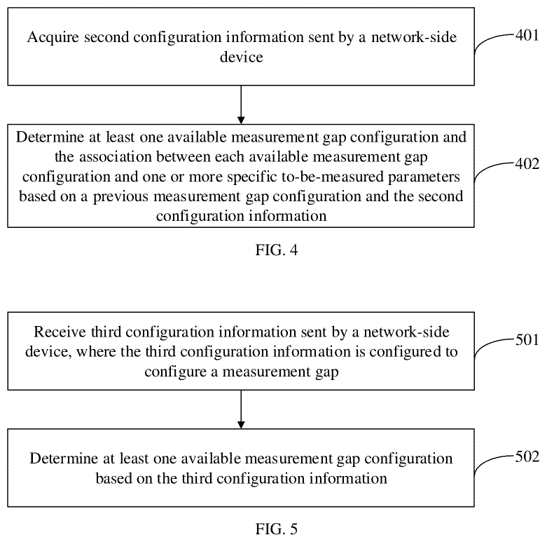

FIG. 4 is a schematic flowchart of an information configuration method provided by an example of the present disclosure, which is performed by UE. The method illustrated in FIG. 4 is configured to determine at least one available measurement gap configuration and an association between each available measurement gap configuration and one or more specific to-be-measured parameters. As illustrated in FIG. 4, the information configuration method may include the following steps.

At step 401, second configuration information sent by a network-side device is acquired, where the second configuration information is configured to configure a measurement gap.

Specifically, in an example of the present disclosure, the second configuration information may include at least one of the following:
a first offset list of the measurement gap, where the first offset list includes at least one measurement gap offset;
a measurement gap offset identifier for indicating the measurement gap offset;
a second offset list of the measurement gap, where the second offset list includes at least one measurement gap offset and a measurement gap offset identifier for indicating the measurement gap offset;
an association between the measurement gap offset and the one or more specific to-be-measured parameters;
an association between the measurement gap offset identifier and the one or more specific to-be-measured parameters;
an association between the measurement gap offset and the one or more identifiers of the one or more specific to-be-measured parameters; or
an association between the measurement gap offset identifier and the one or more identifiers of the one or more specific to-be-measured parameters.

The detailed introduction of the “one or more specific to-be-measured parameters”, the “association between the measurement gap offset and the one or more specific to-be-measured parameters”, the “association between the measurement gap offset identifier and the one or more specific to-be-measured parameters”, the “association between the measurement gap offset and one or more identifiers of the one or more specific to-be-measured parameters”, and the “association between the measurement gap offset identifier and one or more identifiers of the one or more specific to-be-measured parameters” may make reference to the above examples, and is not repeated in the example of the present disclosure.

In an example of the present disclosure, the second configuration information may be configured through a separate IE or message.

It is to be noted that the above message includes but is not limited to an RRC message, a media access control-control element (MAC CE) message, a physical layer message, a broadcast message, etc.

In another example of the present disclosure, the second configuration information may be included in another IE or message for configuration. It is to be noted that the above message includes but is not limited to an RRC message, an MAC CE message, a physical layer message, a broadcast message, etc.

Furthermore, it is to be noted that in an example of the present disclosure, an association identifier may be set for the association that exists between the measurement gap offset or identifier and the one or more specific to-be-measured parameters or identifiers, so as to facilitate storage.

In an example of the present disclosure, the second configuration information may be configured in the following implementation:

one or more of the association identifier, the measurement gap offset, the measurement gap offset identifier, the one or more specific to-be-measured parameters, and the one or more specific to-be-measured parameter identifiers are included in a third parameter. A plurality of third parameters may be included in a sixth list, and the sixth list may be included in the second configuration information. Alternatively, the third parameter is directly included in the second configuration information.

In an example of the present disclosure, other configuration methods of the second configuration information are similar to the configuration methods of the first configuration information in the above examples, and are not repeated in the example of the present disclosure.

At step 402, at least one available measurement gap configuration and the association between each available measurement gap configuration and one or more specific to-be-measured parameters are determined based on a previous measurement gap configuration and the second configuration information.

Specifically, in an example of the present disclosure, the previous measurement gap configuration may include but is not limited to one or more of a measurement gap length, a measurement gap period, a measurement gap timing advance, and a measurement gap offset.

In an example of the present disclosure, the method that the at least one available measurement gap configuration and the association between each available measurement gap configuration and the one or more specific to-be-measured parameters are determined based on the previous measurement gap configuration and the second configuration information may include the following steps.

At step e, the at least one available measurement gap configuration is determined correspondingly based on the previous measurement gap configuration and different measurement gap offsets in the second configuration information.

The detailed method that “the available measurement gap configuration is obtained by applying the measurement gap offset on the basis of the previous measurement gap configuration” may make reference to the description of the above examples, and is not repeated in the example of the present disclosure.

At step f, the association between each available measurement gap configuration and the one or more specific to-be-measured parameters is determined based on the association in the second configuration information.

Specifically, in an example of the present disclosure, after the at least one available measurement gap configuration is determined correspondingly based on different measurement gap offsets, one or more specific to-be-measured parameters associated with the measurement gap offset may be determined as the to-be-measured parameters associated with the available measurement gap configuration corresponding to the measurement gap offset.

For example, in an example of the present disclosure, assuming that available measurement gap configuration #1 is determined based on the measurement gap offset #1, in which the specific to-be-measured parameter associated with the measurement gap offset #1 is to-be-measured cell #1, the specific to-be-measured parameter associated with the available measurement gap configuration #1 is determined as being the to-be-measured cell #1.

For example, in an example of the present disclosure, assuming that available measurement gap configuration #1 is determined based on measurement gap offset #1, in which the specific to-be-measured parameter associated with the measurement gap offset #1 is to-be-measured object #1, the specific to-be-measured parameter associated with the available measurement gap configuration #1 is determined as being the to-be-measured object #1.

Furthermore, it is to be noted that in an example of the present disclosure, the association identifier may be set for the association that exists between the measurement gap offset or identifier and the one or more specific to-be-measured parameters or identifiers, so as to facilitate storage.

In view of the above, in the information configuration method provided by the example of the present disclosure, based on the configuration of the network-side device, the UE determines the at least one available measurement gap configuration and/or the association between each available measurement gap configuration and the one or more specific to-be-measured parameters for indication, and subsequently a corresponding cell or frequency point can be measured based on the association and the at least one available measurement gap configuration. Specifically, in the example of the present disclosure, the UE determines the at least one available measurement gap configuration based on at least one measurement gap offset configured by the network-side device. It can be seen in the examples of the present disclosure that a plurality of available measurement gap configurations can be obtained by configuring only a plurality of measurement gap offsets, resulting in low signaling overheads. Meanwhile, lager number of available measurement gap configurations can be obtained since there is no limit to the number of the configured measurement gap offsets, which can be suitable for measuring a plurality of different to-be-measured cells or frequency points.

FIG. 5 is a schematic flowchart of an information configuration method provided by an example of the present disclosure, which is performed by UE. The method illustrated in FIG. 5 is configured to determine only at least one available measurement gap configuration. As illustrated in FIG. 5, the information configuration method may include the following steps.

At step 501, third configuration information sent by a network-side device is received, where the third configuration information is configured to configure a measurement gap.

Specifically, in an example of the present disclosure, the third configuration information may include at least one of the following:
a measurement gap length;
a measurement gap period;
a measurement gap timing advance;
a first offset list of the measurement gap, where the first offset list includes at least one measurement gap offset;
a measurement gap offset identifier for indicating the measurement gap offset; or
a second offset list of the measurement gap, where the second offset list includes at least one measurement gap offset and a measurement gap offset identifier for indicating the measurement gap offset.

The detailed introduction of the above “one or more specific to-be-measured parameters” may make reference to the above examples, and are not repeated in the example of the present disclosure.

In an example of the present disclosure, the method of receiving the third configuration information sent by the network-side device may include at least one of the following:
receiving the third configuration information sent by the network-side device through an RRC message, where the contents of the third configuration information may be included in the same or different RRC messages;
receiving the third configuration information broadcasted by the network-side device; or
receiving the third configuration information sent by the network-side device through dedicated signaling.

At step 502, at least one available measurement gap configuration is determined based on the third configuration information.

Specifically, in an example of the present disclosure, the method that the at least one available measurement gap configuration is determined based on the third configuration information may include that: the at least one measurement gap offset is first determined based on at least one of the first offset list, the second offset list or the measurement gap offset identifier included in the third configuration information, and then, the at least one available measurement gap configuration is obtained by applying each measurement gap offset on the basis of the measurement gap length, the measurement gap period and the measurement gap timing advance included in the third configuration information.

The method that “the at least one available measurement gap configuration is obtained by applying each measurement gap offset on the basis of the measurement gap length, the measurement gap period and the measurement gap timing advance” may make reference to the description of the above examples, and is not repeated in the example of the present disclosure.

In view of the above, in the information configuration method provided by the example of the present disclosure, based on the configuration of the network-side device, the UE determines the at least one available measurement gap configuration and/or the association between each available measurement gap configuration and the one or more specific to-be-measured parameters for indication, and subsequently a corresponding cell or frequency point can be measured based on the association and the at least one available measurement gap configuration. Specifically, in the example of the present disclosure, the UE determines the at least one available measurement gap configuration based on at least one measurement gap offset configured by the network-side device. It can be seen in the examples of the present disclosure that a plurality of available measurement gap configurations can be obtained by configuring only a plurality of measurement gap offsets, resulting in low signaling overheads. Meanwhile, lager number of available measurement gap configurations can be obtained since there is no limit to the number of the configured measurement gap offsets, which can be suitable for measuring a plurality of different to-be-measured cells or frequency points.

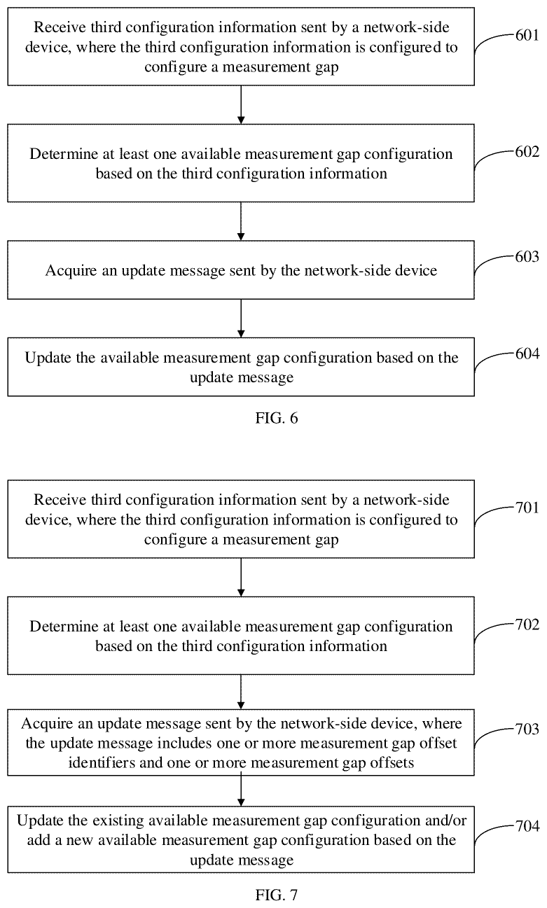

FIG. 6 is a schematic flowchart of an information configuration method provided by an example of the present disclosure, which is performed by UE. The method illustrated in FIG. 6 is configured to determine only at least one available measurement gap configuration. As illustrated in FIG. 6, the information configuration method may include the following steps.

At step 601, third configuration information sent by a network-side device is received, where the third configuration information is configured to configure a measurement gap.

At step 602, at least one available measurement gap configuration is determined based on the third configuration information.

The detailed introduce of steps 601-602 may make reference to the description of the above examples, and is not repeated in the example of the present disclosure.

At step 603, an update message sent by the network-side device is acquired.

At step 604, the available measurement gap configuration is updated based on the update message.

In an example of the present disclosure, since one or more cells corresponding to each satellite rapidly move due to rapid movement of the satellite, transmission delay difference between various cells changes in real time and thus the measurement gap configurations need to be updated at any time. Based on this, in an example of the present disclosure, the above update message may include a measurement gap offset identifier. Then, the UE may update the available measurement gap configuration based on the measurement gap offset identifier sent by the network-side device, so that the updated available measurement gap configuration can be suitable for measuring the various cells after moving. Furthermore, in the example of the present disclosure, the update of the available measurement gap configuration can be achieved by sending the measurement gap offset identifier without reconfiguring the entire measurement gap configuration, which required less signaling resources, thus saving signaling overhead.

The detailed implementation method of steps 603-604 is to be described in detail in the subsequent examples.

In view of the above, in the information configuration method provided by the example of the present disclosure, based on the configuration of the network-side device, the UE determines the at least one available measurement gap configuration and/or the association between each available measurement gap configuration and the one or more specific to-be-measured parameters for indication, and subsequently a corresponding cell or frequency point can be measured based on the association and the at least one available measurement gap configuration. Specifically, in the example of the present disclosure, the UE determines the at least one available measurement gap configuration based on at least one measurement gap offset configured by the network-side device. It can be seen in the examples of the present disclosure that a plurality of available measurement gap configurations can be obtained by configuring only a plurality of measurement gap offsets, resulting in low signaling overheads. Meanwhile, lager number of available measurement gap configurations can be obtained since there is no limit to the number of the configured measurement gap offsets, which can be suitable for measuring a plurality of different to-be-measured cells or frequency points.

FIG. 7 is a schematic flowchart of an information configuration method provided by an example of the present disclosure, which is performed by UE. The method illustrated in FIG. 7 is configured to determine only at least one available measurement gap configuration. As illustrated in FIG. 7, the information configuration method may include the following steps.

At step 701, third configuration information sent by a network-side device is received, where the third configuration information is configured to configure a measurement gap.

At step 702, at least one available measurement gap configuration is determined based on the third configuration information.

The detailed introduce of steps 701-702 may make reference to the description of the above examples, and is not repeated in the example of the present disclosure.

At step 703, an update message sent by the network-side device is acquired, where the update message includes one or more measurement gap offset identifiers and corresponding measurement gap offsets.

In an example, the plurality of measurement gap offset identifiers and measurement gap offsets may be represented by a list.

At step 704, the existing available measurement gap configuration is updated and/or a new available measurement gap configuration is added based on the update message.

Specifically, in an example of the present disclosure, the method of updating the existing available measurement gap configuration and/or adding the new available measurement gap configuration based on the update message may include the following steps.

At step 1, it is determined whether the measurement gap offset identifier included in the update message exists.

At step 2, a measurement gap offset corresponding to the measurement gap offset identifier included in the update message is updated based on the measurement gap offset included in the update message in response to determining that the measurement gap offset identifier included in the update message exists.

At step 3, a new available measurement gap configuration is added based on the measurement gap offset and the measurement gap offset identifier included in the update message in response to determining that the measurement gap offset identifier included in the update message does not exist.

For example, in an example of the present disclosure, it is assumed that the update message received in the above step 703 includes measurement gap offset identifier M and measurement gap offset f. In this case, if it is determined that an available measurement gap configuration corresponding to the identifier M exists in the UE, a new available measurement gap configuration may be recalculated based on the measurement gap offset f, and the new available measurement gap configuration may be updated and determined as being the available measurement gap configuration corresponding to the identifier M. If it is determined that no available measurement gap configuration corresponding to the identifier M exists in the UE, a new available measurement gap configuration may be calculated based on the measurement gap offset f, and the new available measurement gap configuration may be added to the UE.

In addition, it is to be noted that in an example of the present disclosure, the update message may also include an update indication, one or more measurement gap offset identifiers and corresponding measurement gap offsets. After receiving the update message, the UE may update the available measurement gap configurations corresponding to the one or more measurement gap offset identifiers included in the update message by applying the measurement gap offsets included in the update message based on the update indication.

In another example of the present disclosure, the update message may include only one or more measurement gap offset identifiers and measurement gap offsets. After receiving the update message, the UE may update the available measurement gap configurations corresponding to the one or more measurement gap offset identifiers included in the update message by directly applying the one or more measurement gap offset identifiers and measurement gap offsets included in the update message.

In another example of the present disclosure, the update message may also include an add indication and one or more measurement gap offset identifiers and measurement gap offsets. After receiving the update message, the UE may add the available measurement gap configurations by applying the one or more measurement gap offset identifiers and measurement gap offsets included in the update message based on the add indication.

In another example of the present disclosure, the update message may also be an add message, and the add message includes one or more measurement gap offset identifiers and measurement gap offsets. After receiving the add message, the UE may add the available measurement gap configurations by applying directly the one or more measurement gap offset identifiers and measurement gap offsets included in the add message.

In view of the above, in the information configuration method provided by the example of the present disclosure, based on the configuration of the network-side device, the UE determines the at least one available measurement gap configuration and/or the association between each available measurement gap configuration and the one or more specific to-be-measured parameters for indication, and subsequently a corresponding cell or frequency point can be measured based on the association and the at least one available measurement gap configuration. Specifically, in the example of the present disclosure, the UE determines the at least one available measurement gap configuration based on at least one measurement gap offset configured by the network-side device. It can be seen in the examples of the present disclosure that a plurality of available measurement gap configurations can be obtained by configuring only a plurality of measurement gap offsets, resulting in low signaling overheads. Meanwhile, lager number of available measurement gap configurations can be obtained since there is no limit to the number of the configured measurement gap offsets, which can be suitable for measuring a plurality of different to-be-measured cells or frequency points.

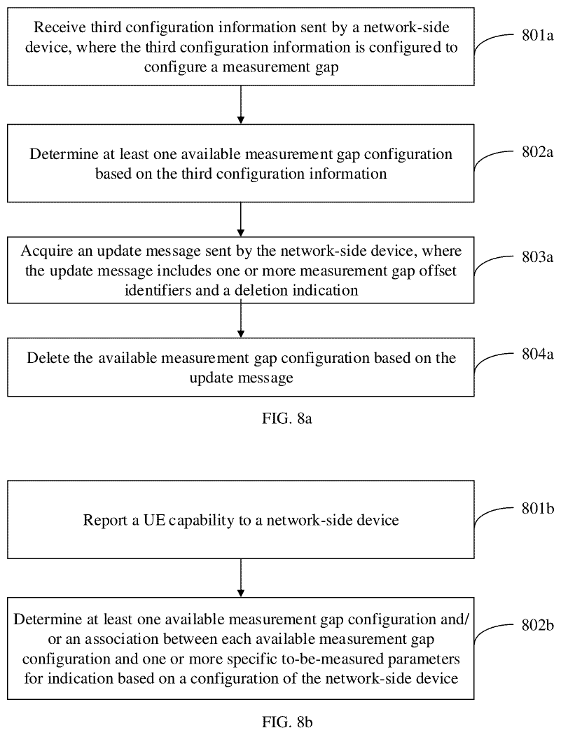

FIG. 8a is a schematic flowchart of an information configuration method provided by an example of the present disclosure, which is performed by UE. The method illustrated in FIG. 8a is configured to determine only at least one available measurement gap configuration. As illustrated in FIG. 8a, the information configuration method may include the following steps.

At step 801a, third configuration information sent by a network-side device is received, where the third configuration information is configured to configure a measurement gap.

At step 802a, at least one available measurement gap configuration is determined based on the third configuration information.

The detailed introduce of steps 801-802 may make reference to the description of the above examples, and is not repeated in the example of the present disclosure.

At step 803a, an update message sent by the network-side device is acquired, where the update message includes one or more measurement gap offset identifiers and a deletion indication.

At step 804a, the available measurement gap configuration is deleted based on the update message.

Specifically, in an example of the present disclosure, the method of deleting the available measurement gap configuration based on the update message may include: deleting the available measurement gap configuration corresponding to the measurement gap offset identifier included in the update message based on the deletion indication.

For example, in an example of the present disclosure, it is assumed that the update message received in the above step 803 includes measurement gap offset identifier M and the deletion indication. In this case, the UE may directly delete the available measurement gap configuration corresponding to the identifier M based on the deletion indication.

In an example of the present disclosure, the update message may be one deletion message, which includes one or more measurement gap offset identifiers. After receiving the deletion message, the UE may directly delete the available measurement gap configuration corresponding to the measurement gap offset identifier included in the deletion message.

In view of the above, in the information configuration method provided by the example of the present disclosure, based on the configuration of the network-side device, the UE determines the at least one available measurement gap configuration and/or the association between each available measurement gap configuration and the one or more specific to-be-measured parameters for indication, and subsequently a corresponding cell or frequency point can be measured based on the association and the at least one available measurement gap configuration. Specifically, in the example of the present disclosure, the UE determines the at least one available measurement gap configuration based on at least one measurement gap offset configured by the network-side device. It can be seen in the examples of the present disclosure that a plurality of available measurement gap configurations can be obtained by configuring only a plurality of measurement gap offsets, resulting in low signaling overheads. Meanwhile, lager number of available measurement gap configurations can be obtained since there is no limit to the number of the configured measurement gap offsets, which can be suitable for measuring a plurality of different to-be-measured cells or frequency points.

FIG. 8b is a schematic flowchart of an information configuration method provided by an example of the present disclosure. The method is performed by UE. As illustrated in FIG. 8b, the information configuration method may include the following steps.

At step 801b, a UE capability is reported to a network-side device.

Specifically, in an example of the present disclosure, it may be a UE capability of configuring a plurality of measurement gap offsets for the UE, which may indicate whether the UE is capable of supporting to configure one or more measurement gap offsets.

For example, in an example of the present disclosure, the number of the plurality of measurement gap offsets may be specified. As an example, the UE capability may indicate that the UE supports or does not support to configure 4 measurement gap offsets.

For example, in another example of the present disclosure, the number of the plurality of measurement gap offsets may be at least a maximum supported number. As an example, the UE capability may indicate that the UE supports or does not support to configure at least 4 measurement gap offsets.

Furthermore, in another example of the present disclosure, it may be a UE capability of configuring an association for the UE (i.e., the association between one or more measurement gap offsets and the one or more specific to-be-measured parameters), which may indicate whether the UE can support to configure the association.

For example, in an example of the present disclosure, the UE capability may indicate whether the UE supports or does not support to configure the association.

Furthermore, in another example of the present disclosure, the UE capability may indicate whether the UE supports to simultaneously configure X measurement gap configurations per UE and/or simultaneously configure Y measurement gap configurations for FR1 and/or simultaneously configure Z measurement gap configurations for FR2.

In an example of the present disclosure, X and/or Y and/or Z may constitute different combinations, and the different combinations may correspond to different combination identifiers.

Based on this, in another example of the present disclosure, the UE capability may indicate that the UE supports or doesn't support the combination or combination mode identifier.

For example, in an example of the present disclosure, the UE capability may indicate that the UE supports or does not support one or more combinations.

At step 802b, at least one available measurement gap configuration and/or an association between each available measurement gap configuration and one or more specific to-be-measured parameters for indication are determined based on a configuration of the network-side device.

The detailed introduce of step 802b may make reference to the description of the above examples, and is not repeated in the example of the present disclosure.

In view of the above, in the information configuration method provided by the example of the present disclosure, based on the configuration of the network-side device, the UE determines the at least one available measurement gap configuration and/or the association between each available measurement gap configuration and the one or more specific to-be-measured parameters for indication, and subsequently a corresponding cell or frequency point can be measured based on the association and the at least one available measurement gap configuration. Specifically, in the example of the present disclosure, the UE determines the at least one available measurement gap configuration based on at least one measurement gap offset configured by the network-side device. It can be seen in the examples of the present disclosure that a plurality of available measurement gap configurations can be obtained by configuring only a plurality of measurement gap offsets, resulting in low signaling overheads. Meanwhile, lager number of available measurement gap configurations can be obtained since there is no limit to the number of the configured measurement gap offsets, which can be suitable for measuring a plurality of different to-be-measured cells or frequency points.

In addition, it is to be noted that in the present disclosure, the above examples may be implemented separately or in combination. The separate implementation and the combined implementation of various examples are all within the protection scope of this patent.

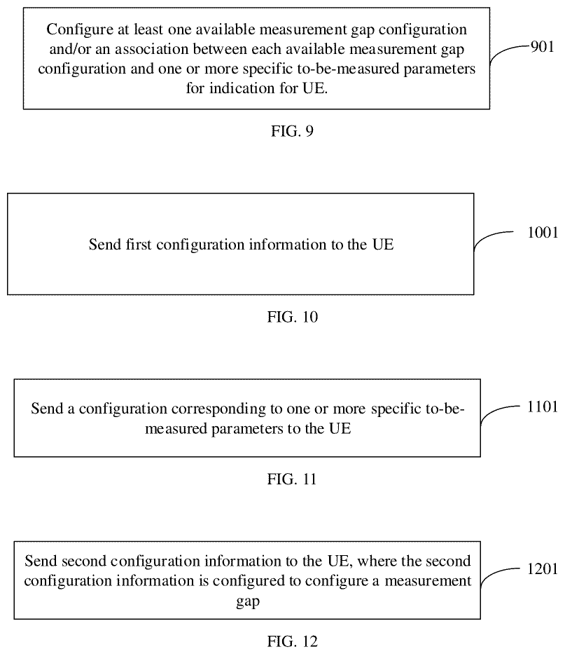

FIG. 9 is a schematic flowchart of an information configuration method provided by an example of the present disclosure. The method is performed by a network-side device. As illustrated in FIG. 9, the information configuration method may include the following step.

At step 901, at least one available measurement gap configuration and/or an association between each available measurement gap configuration and one or more specific to-be-measured parameters for indication are configured for UE.

Specifically, in an example of the present disclosure, the detailed introduction of the one or more specific to-be-measured parameters may make reference to the description of the above examples, and is not repeated in the example of the present disclosure.

In an example of the present disclosure, the network-side device may configure the at least one available measurement gap configuration and the association between each available measurement gap configuration and the one or more specific to-be-measured parameters for the UE.

In another example of the present disclosure, the network-side device may configure only at least one available measurement gap configuration for the UE.

The above method that “the network-side device determines the at least one available measurement gap configuration and the association between each available measurement gap configuration and the one or more specific to-be-measured parameters for the UE” and the method that “the network-side device determines only the at least one available measurement gap configuration for the UE” are introduced in detail in subsequent examples.

In addition, it is to be noted that in an example of the present disclosure, the above available measurement gap configuration may be a gap configuration per UE. In another example of the present disclosure, the above available measurement gap configuration may be a gap configuration per FR.

In view of the above, in the information configuration method provided by the example of the present disclosure, based on the configuration of the network-side device, the UE determines the at least one available measurement gap configuration and/or the association between each available measurement gap configuration and the one or more specific to-be-measured parameters for indication, and subsequently a corresponding cell or frequency point can be measured based on the association and the at least one available measurement gap configuration. Specifically, in the example of the present disclosure, the UE determines the at least one available measurement gap configuration based on at least one measurement gap offset configured by the network-side device. It can be seen in the examples of the present disclosure that a plurality of available measurement gap configurations can be obtained by configuring only a plurality of measurement gap offsets, resulting in low signaling overheads. Meanwhile, lager number of available measurement gap configurations can be obtained since there is no limit to the number of the configured measurement gap offsets, which can be suitable for measuring a plurality of different to-be-measured cells or frequency points.

FIG. 10 is a schematic flowchart of an information configuration method provided by an example of the present disclosure, which is performed by a network-side device. The method illustrated in FIG. 10 is configured for the network-side device to configure at least one available measurement gap configuration and an association between each available measurement gap configuration and one or more specific to-be-measured parameters for UE. As illustrated in FIG. 10, the information configuration method may include the following step.

At step 1001, first configuration information is sent to the UE, where the first configuration information may include at least one measurement gap offset and the one or more specific to-be-measured parameters associated with each measurement gap offset.

Specifically, the detailed introduce of step 1001 may make reference to the description of the above examples, and is not repeated in the example of the present disclosure.

In view of the above, in the information configuration method provided by the example of the present disclosure, based on the configuration of the network-side device, the UE determines the at least one available measurement gap configuration and/or the association between each available measurement gap configuration and the one or more specific to-be-measured parameters for indication, and subsequently a corresponding cell or frequency point can be measured based on the association and the at least one available measurement gap configuration. Specifically, in the example of the present disclosure, the UE determines the at least one available measurement gap configuration based on at least one measurement gap offset configured by the network-side device. It can be seen in the examples of the present disclosure that a plurality of available measurement gap configurations can be obtained by configuring only a plurality of measurement gap offsets, resulting in low signaling overheads. Meanwhile, lager number of available measurement gap configurations can be obtained since there is no limit to the number of the configured measurement gap offsets, which can be suitable for measuring a plurality of different to-be-measured cells or frequency points.

FIG. 11 is a schematic flowchart of an information configuration method provided by an example of the present disclosure, which is performed by a network-side device. The method illustrated in FIG. 11 is configured for the network-side device to configure at least one available measurement gap configuration and an association between each available measurement gap configuration and one or more specific to-be-measured parameters for UE. As illustrated in FIG. 11, the information configuration method may include the following step.

At step 1101, a configuration corresponding to one or more specific to-be-measured parameters and either at least one measurement gap offset or at least one measurement gap offset identifier are sent to the UE, where the configuration corresponding to the one or more specific to-be-measured parameters includes an association between the one or more specific to-be-measured parameters and either the measurement gap offset or the measurement gap offset identifier.

Specifically, the detailed introduce of step 1101 may make reference to the description of the above examples, and is not repeated in the example of the present disclosure.

In view of the above, in the information configuration method provided by the example of the present disclosure, based on the configuration of the network-side device, the UE determines the at least one available measurement gap configuration and/or the association between each available measurement gap configuration and the one or more specific to-be-measured parameters for indication, and subsequently a corresponding cell or frequency point can be measured based on the association and the at least one available measurement gap configuration. Specifically, in the example of the present disclosure, the UE determines the at least one available measurement gap configuration based on at least one measurement gap offset configured by the network-side device. It can be seen in the examples of the present disclosure that a plurality of available measurement gap configurations can be obtained by configuring only a plurality of measurement gap offsets, resulting in low signaling overheads. Meanwhile, lager number of available measurement gap configurations can be obtained since there is no limit to the number of the configured measurement gap offsets, which can be suitable for measuring a plurality of different to-be-measured cells or frequency points.

FIG. 12 is a schematic flowchart of an information configuration method provided by an example of the present disclosure, which is performed by a network-side device. The method illustrated in FIG. 12 is configured for the network-side device to configure at least one available measurement gap configuration and an association between each available measurement gap configuration and one or more specific to-be-measured parameters for UE. As illustrated in FIG. 12, the information configuration method may include the following step.

At step 1201, second configuration information is sent to the UE, where the second configuration information is configured to configure a measurement gap.

Specifically, the detailed introduce of step 1201 may make reference to the description of the above examples, and is not repeated in the example of the present disclosure.

In view of the above, in the information configuration method provided by the example of the present disclosure, based on the configuration of the network-side device, the UE determines the at least one available measurement gap configuration and/or the association between each available measurement gap configuration and the one or more specific to-be-measured parameters for indication, and subsequently a corresponding cell or frequency point can be measured based on the association and the at least one available measurement gap configuration. Specifically, in the example of the present disclosure, the UE determines the at least one available measurement gap configuration based on at least one measurement gap offset configured by the network-side device. It can be seen in the examples of the present disclosure that a plurality of available measurement gap configurations can be obtained by configuring only a plurality of measurement gap offsets, resulting in low signaling overheads. Meanwhile, lager number of available measurement gap configurations can be obtained since there is no limit to the number of the configured measurement gap offsets, which can be suitable for measuring a plurality of different to-be-measured cells or frequency points.

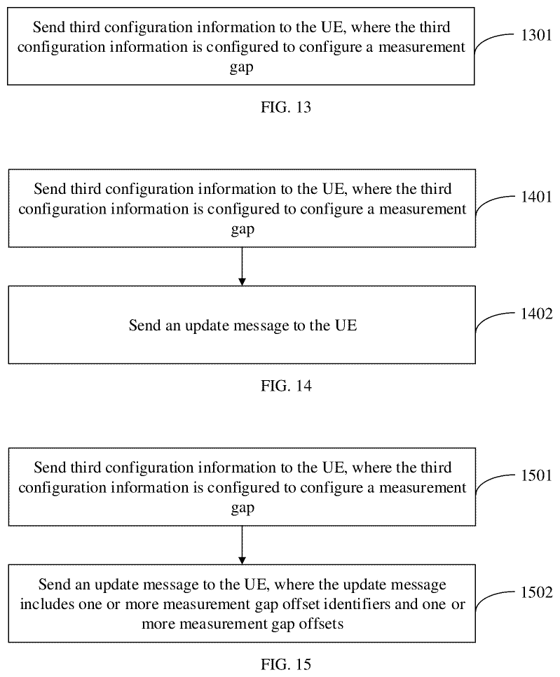

FIG. 13 is a schematic flowchart of an information configuration method provided by an example of the present disclosure, which is performed by a network-side device. The method illustrated in FIG. 13 is configured for the network-side device to configure only at least one available measurement gap configuration for UE. As illustrated in FIG. 13, the information configuration method may include the following step.

At step 1301, third configuration information is sent to the UE, where the third configuration information is configured to configure a measurement gap.

Specifically, the detailed introduce of step 1301 may make reference to the description of the above examples, and is not repeated in the example of the present disclosure.

In view of the above, in the information configuration method provided by the example of the present disclosure, based on the configuration of the network-side device, the UE determines the at least one available measurement gap configuration and/or the association between each available measurement gap configuration and the one or more specific to-be-measured parameters for indication, and subsequently a corresponding cell or frequency point can be measured based on the association and the at least one available measurement gap configuration. Specifically, in the example of the present disclosure, the UE determines the at least one available measurement gap configuration based on at least one measurement gap offset configured by the network-side device. It can be seen in the examples of the present disclosure that a plurality of available measurement gap configurations can be obtained by configuring only a plurality of measurement gap offsets, resulting in low signaling overheads. Meanwhile, lager number of available measurement gap configurations can be obtained since there is no limit to the number of the configured measurement gap offsets, which can be suitable for measuring a plurality of different to-be-measured cells or frequency points.

FIG. 14 is a schematic flowchart of an information configuration method provided by an example of the present disclosure, which is performed by a network-side device. The method illustrated in FIG. 14 is configured for the network-side device to configure only at least one available measurement gap configuration for UE. As illustrated in FIG. 14, the information configuration method may include the following steps.

At step 1401, third configuration information is sent to the UE, where the third configuration information is configured to configure a measurement gap.

At step 1402, an update message is sent to the UE.

Specifically, the detailed introduce of steps 1401-1402 may make reference to the description of the above examples, and is not repeated in the examples of the present disclosure.

In view of the above, in the information configuration method provided by the example of the present disclosure, based on the configuration of the network-side device, the UE determines the at least one available measurement gap configuration and/or the association between each available measurement gap configuration and the one or more specific to-be-measured parameters for indication, and subsequently a corresponding cell or frequency point can be measured based on the association and the at least one available measurement gap configuration. Specifically, in the example of the present disclosure, the UE determines the at least one available measurement gap configuration based on at least one measurement gap offset configured by the network-side device. It can be seen in the examples of the present disclosure that a plurality of available measurement gap configurations can be obtained by configuring only a plurality of measurement gap offsets, resulting in low signaling overheads. Meanwhile, lager number of available measurement gap configurations can be obtained since there is no limit to the number of the configured measurement gap offsets, which can be suitable for measuring a plurality of different to-be-measured cells or frequency points.

FIG. 15 is a schematic flowchart of an information configuration method provided by an example of the present disclosure, which is performed by a network-side device. The method illustrated in FIG. 15 is configured for the network-side device to configure only at least one available measurement gap configuration for UE. As illustrated in FIG. 15, the information configuration method may include the following steps.

At step 1501, third configuration information is sent to the UE, where the third configuration information is configured to configure a measurement gap.

At step 1502, an update message is sent to the UE, where the update message includes one or more measurement gap offset identifiers and one or more measurement gap offsets.

Specifically, the detailed introduce of steps 1501-1502 may make reference to the description of the above examples, and is not repeated in the example of the present disclosure.

In view of the above, in the information configuration method provided by the example of the present disclosure, based on the configuration of the network-side device, the UE determines the at least one available measurement gap configuration and/or the association between each available measurement gap configuration and the one or more specific to-be-measured parameters for indication, and subsequently a corresponding cell or frequency point can be measured based on the association and the at least one available measurement gap configuration. Specifically, in the example of the present disclosure, the UE determines the at least one available measurement gap configuration based on at least one measurement gap offset configured by the network-side device. It can be seen in the examples of the present disclosure that a plurality of available measurement gap configurations can be obtained by configuring only a plurality of measurement gap offsets, resulting in low signaling overheads. Meanwhile, lager number of available measurement gap configurations can be obtained since there is no limit to the number of the configured measurement gap offsets, which can be suitable for measuring a plurality of different to-be-measured cells or frequency points.

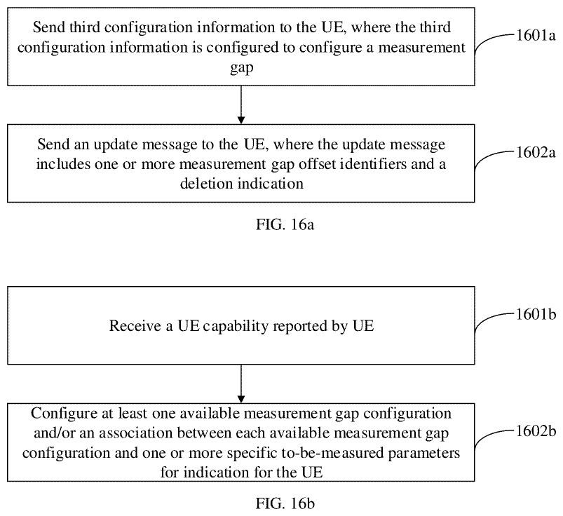

FIG. 16a is a schematic flowchart of an information configuration method provided by an example of the present disclosure, which is performed by a network-side device. The method illustrated in FIG. 16a is configured for the network-side device to configure only at least one available measurement gap configuration for UE. As illustrated in FIG. 16a, the information configuration method may include the following steps.

At step 1601a, third configuration information is sent to the UE, where the third configuration information is configured to configure a measurement gap.

At step 1602a, an update message is sent to the UE, where the update message includes one or more measurement gap offset identifiers and a deletion indication.

Specifically, the detailed introduce of steps 1601a-1602a may make reference to the description of the above examples, and is not repeated in the example of the present disclosure.

In view of the above, in the information configuration method provided by the example of the present disclosure, based on the configuration of the network-side device, the UE determines the at least one available measurement gap configuration and/or the association between each available measurement gap configuration and the one or more specific to-be-measured parameters for indication, and subsequently a corresponding cell or frequency point can be measured based on the association and the at least one available measurement gap configuration. Specifically, in the example of the present disclosure, the UE determines the at least one available measurement gap configuration based on at least one measurement gap offset configured by the network-side device. It can be seen in the examples of the present disclosure that a plurality of available measurement gap configurations can be obtained by configuring only a plurality of measurement gap offsets, resulting in low signaling overheads. Meanwhile, lager number of available measurement gap configurations can be obtained since there is no limit to the number of the configured measurement gap offsets, which can be suitable for measuring a plurality of different to-be-measured cells or frequency points.

FIG. 16b is a schematic flowchart of an information configuration method provided by an example of the present disclosure. The method is performed by a network-side device. As illustrated in FIG. 16b, the information configuration method may include the following steps.

At step 1601b, a UE capability reported by UE is received.

At step 1602b, at least one available measurement gap configuration and/or an association between each available measurement gap configuration and one or more specific to-be-measured parameters for indication are configured for the UE.

Specifically, the detailed introduce of steps 1601b-1602b may make reference to the description of the above examples, and is not repeated in the example of the present disclosure.

In view of the above, in the information configuration method provided by the example of the present disclosure, based on the configuration of the network-side device, the UE determines the at least one available measurement gap configuration and/or the association between each available measurement gap configuration and the one or more specific to-be-measured parameters for indication, and subsequently a corresponding cell or frequency point can be measured based on the association and the at least one available measurement gap configuration. Specifically, in the example of the present disclosure, the UE determines the at least one available measurement gap configuration based on at least one measurement gap offset configured by the network-side device. It can be seen in the examples of the present disclosure that a plurality of available measurement gap configurations can be obtained by configuring only a plurality of measurement gap offsets, resulting in low signaling overheads. Meanwhile, lager number of available measurement gap configurations can be obtained since there is no limit to the number of the configured measurement gap offsets, which can be suitable for measuring a plurality of different to-be-measured cells or frequency points.

FIG. 17 is a structure schematic diagram of an information configuration apparatus 1700 provided by an example of the present disclosure. As illustrated in FIG. 17, the information configuration apparatus may include the following module:
a determining module 1701 that is configured to determine, based on a configuration of a network-side device, at least one available measurement gap configuration and/or an association between each available measurement gap configuration and one or more specific to-be-measured parameters for indication.

In view of the above, in the information configuration apparatus provided by the example of the present disclosure, based on the configuration of the network-side device, the UE determines the at least one available measurement gap configuration and/or the association between each available measurement gap configuration and the one or more specific to-be-measured parameters for indication, and subsequently a corresponding cell or frequency point can be measured based on the association and the at least one available measurement gap configuration. Specifically, in the example of the present disclosure, the UE determines the at least one available measurement gap configuration based on at least one measurement gap offset configured by the network-side device. It can be seen in the example of the present disclosure that a plurality of available measurement gap configurations can be obtained by configuring only a plurality of measurement gap offsets, resulting in low signaling overheads. Meanwhile, lager number of available measurement gap configurations can be obtained since there is no limit to the number of the configured measurement gap offsets, which can be suitable for measuring a plurality of different to-be-measured cells or frequency points.

Alternatively or additionally, in an example of the present disclosure, the one or more specific to-be-measured parameters may include at least one of the following:
a measurement object;
a to-be-measured frequency;
a to-be-measured cell;
a to-be-measured satellite; or
an SMTC configuration.

Alternatively or additionally, in an example of the present disclosure, the determining module is further configured to:
determine, based on the configuration of the network-side device, the at least one available measurement gap configuration and the association between each available measurement gap configuration and the one or more specific to-be-measured parameters.

Alternatively or additionally, in an example of the present disclosure, the determining module is further configured to:
acquire first configuration information sent by the network-side device, where the first configuration information includes at least one measurement gap offset and the one or more specific to-be-measured parameters associated with each measurement gap offset; and
determine, based on a previous measurement gap configuration and the first configuration information, the at least one available measurement gap configuration and the association between each available measurement gap configuration and the one or more specific to-be-measured parameters, where the previous measurement gap configuration includes one or more of a measurement gap length, a measurement gap period and a measurement gap timing advance.

Alternatively or additionally, in an example of the present disclosure, the determining module is further configured to:
acquire a configuration corresponding to the one or more specific to-be-measured parameters and either at least one measurement gap offset or at least one measurement gap offset identifier sent by the network-side device, where the configuration corresponding to the one or more specific to-be-measured parameters includes an association between the one or more specific to-be-measured parameters and either the measurement gap offset or the measurement gap offset identifier; and
determine the at least one available measurement gap configuration and the association between each available measurement gap configuration and the one or more specific to-be-measured parameters based on the previous measurement gap configuration, either the at least one measurement gap offset or the at least one measurement gap offset identifier and the configuration corresponding to the one or more specific to-be-measured parameters, where the previous measurement gap configuration includes one or more of the measurement gap length, the measurement gap period and the measurement gap timing advance.

Alternatively or additionally, in an example of the present disclosure, the determining module is further configured to:
acquire second configuration information sent by the network-side device, where the second configuration information is configured to configure a measurement gap; and
determine, based on the previous measurement gap configuration and the second configuration information, the at least one available measurement gap configuration and the association between each available measurement gap configuration and the one or more specific to-be-measured parameters, where the previous measurement gap configuration includes one or more of the measurement gap length, the measurement gap period, and the measurement gap timing advance.

Alternatively or additionally, in an example of the present disclosure, the second configuration information may include at least one of the following:
a first offset list of the measurement gap, where the first offset list includes at least one measurement gap offset;
a measurement gap offset identifier for indicating the measurement gap offset; or
a second offset list of the measurement gap, where the second offset list includes at least one measurement gap offset and a measurement gap offset identifier for indicating the measurement gap offset;
an association between the measurement gap offset and the one or more specific to-be-measured parameters;
an association between the measurement gap offset identifier and the one or more specific to-be-measured parameters;
an association between the measurement gap offset and one or more identifiers of the one or more specific to-be-measured parameters; or
an association between the measurement gap offset identifier and one or more identifiers of the one or more specific to-be-measured parameters.

Alternatively or additionally, in an example of the present disclosure, the determining module is further configured to:
determine the at least one available measurement gap configuration based on the configuration of the network-side device.

Alternatively or additionally, in an example of the present disclosure, the determining module is further configured to: receive third configuration information sent by the network-side device, where the third configuration information is configured to configure a measurement gap; and
determine the at least one available measurement gap configuration based on the third configuration information.

Alternatively or additionally, in an example of the present disclosure, the third configuration information may include at least one of the following:
a measurement gap length;
a measurement gap period;
a measurement gap timing advance;
a first offset list of the measurement gap, where the first offset list includes at least one measurement gap offset;
a measurement gap offset identifier for indicating the measurement gap offset; or
a second offset list of the measurement gap, where the second offset list includes at least one measurement gap offset and a measurement gap offset identifier for indicating the measurement gap offset.

Alternatively or additionally, in an example of the present disclosure, the determining module is further configured to:
receive the third configuration information sent by the network-side device through an RRC message; and/or
receive the third configuration information broadcasted by the network-side device; and/or
receive the third configuration information sent by the network-side device through dedicated signaling.

Alternatively or additionally, in an example of the present disclosure, the apparatus is further configured to:
acquire an update message sent by the network-side device; and
update the available measurement gap configuration based on the update message.

Alternatively or additionally, in an example of the present disclosure, the update message includes one or more measurement gap offset identifiers and one or more measurement gap offsets.

The apparatus is further configured to:
determine whether the measurement gap offset identifier included in the update message exists;
update, in response to determining that the measurement gap offset identifier included in the update message exists, a measurement gap offset corresponding to the measurement gap offset identifier included in the update message based on the measurement gap offset included in the update message; and
add, in response to determining that the measurement gap offset identifier included in the update message does not exist, a new available measurement gap configuration based on the measurement gap offset and the measurement gap offset identifier included in the update message.

Alternatively or additionally, in an example of the present disclosure, the update message includes one or more measurement gap offset identifiers and a deletion indication.

The apparatus is further configured to:
delete the available measurement gap configuration corresponding to the measurement gap offset identifier included in the update message based on the deletion indication.

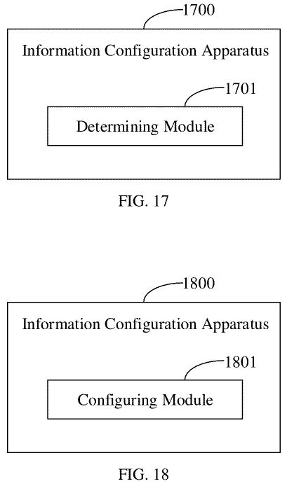

FIG. 18 is a structure schematic diagram of an information configuration apparatus 1700 provided by an example of the present disclosure. As illustrated in FIG. 18, the information configuration apparatus may include the following module:
a configuring module, configured to configure for UE at least one available measurement gap configuration and/or an association between each available measurement gap configuration and one or more specific to-be-measured parameters for indication.

In view of the above, in the information configuration apparatus provided by the example of the present disclosure, based on the configuration of the network-side device, the UE determines the at least one available measurement gap configuration and/or the association between each available measurement gap configuration and the one or more specific to-be-measured parameters for indication, and subsequently a corresponding cell or frequency point can be measured based on the association and the at least one available measurement gap configuration. Specifically, in the example of the present disclosure, the UE determines the at least one available measurement gap configuration based on at least one measurement gap offset configured by the network-side device. It can be seen in the example of the present disclosure that a plurality of available measurement gap configurations can be obtained by configuring only a plurality of measurement gap offsets, resulting in low signaling overheads. Meanwhile, lager number of available measurement gap configurations can be obtained since there is no limit to the number of the configured measurement gap offsets, which can be suitable for measuring a plurality of different to-be-measured cells or frequency points.

Alternatively or additionally, in an example of the present disclosure, the one or more specific to-be-measured parameters may include at least one of the following:
a measurement object;
a to-be-measured frequency;
a to-be-measured cell;
a to-be-measured satellite; or
an SMTC configuration.

Alternatively or additionally, in an example of the present disclosure, the configuring module is further configured to:
configure for the UE the at least one available measurement gap configuration and the association between each available measurement gap configuration and the one or more specific to-be-measured parameters.

Alternatively or additionally, in an example of the present disclosure, the determining module is further configured to:
send first configuration information to the UE, where the first configuration information includes at least one measurement gap offset and the one or more specific to-be-measured parameters associated with each measurement gap offset.

Alternatively or additionally, in an example of the present disclosure, the configuring module is further configured to:
send a configuration corresponding to the one or more specific to-be-measured parameters and either at least one measurement gap offset or at least one measurement gap offset identifier to the UE, where the configuration corresponding to the one or more specific to-be-measured parameters includes an association between the one or more specific to-be-measured parameters and either the measurement gap offset or the measurement gap offset identifier.

Alternatively or additionally, in an example of the present disclosure, the configuring module is further configured to:
send second configuration information to the UE, where the second configuration information is configured to configure a measurement gap.

Alternatively or additionally, in an example of the present disclosure, the second configuration information may include at least one of the following:
a first offset list of the measurement gap, where the first offset list includes at least one measurement gap offset;
a measurement gap offset identifier for indicating the measurement gap offset; or
a second offset list of the measurement gap, where the second offset list includes at least one measurement gap offset and a measurement gap offset identifier for indicating the measurement gap offset;
an association between the measurement gap offset and the one or more specific to-be-measured parameters;
an association between the measurement gap offset identifier and the one or more specific to-be-measured parameters;
an association between the measurement gap offset and one or more identifiers of the one or more specific to-be-measured parameters; or
an association between the measurement gap offset identifier and one or more identifiers of the one or more specific to-be-measured parameters.

Alternatively or additionally, in an example of the present disclosure, the configuring module is further configured to:
configure for the UE the at least one available measurement gap configuration.

Alternatively or additionally, in an example of the present disclosure, the configuring module is further configured to:
send third configuration information to the UE, where the third configuration information is configured to configure a measurement gap.

Alternatively or additionally, in an example of the present disclosure, the third configuration information may include at least one of the following:
a measurement gap length;
a measurement gap period;
a measurement gap timing advance;
a first offset list of the measurement gap, where the first offset list includes at least one measurement gap offset;
a measurement gap offset identifier for indicating the measurement gap offset; or
a second offset list of the measurement gap, where the second offset list includes at least one measurement gap offset and a measurement gap offset identifier for indicating the measurement gap offset.

Alternatively or additionally, in an example of the present disclosure, the configuring module is further configured to:
send the third configuration information to the UE through an RRC message; and/or broadcast the third configuration information to the UE; and/or
send the third configuration information to the UE through dedicated signaling.

Alternatively or additionally, in an example of the present disclosure, the apparatus is further configured to:
send an update message to the UE.

Alternatively or additionally, in an example of the present disclosure, the update message includes one or more measurement gap offset identifiers and one or more measurement gap offsets.

Alternatively or additionally, in an example of the present disclosure, the update message includes one or more measurement gap offset identifiers and a deletion indication.

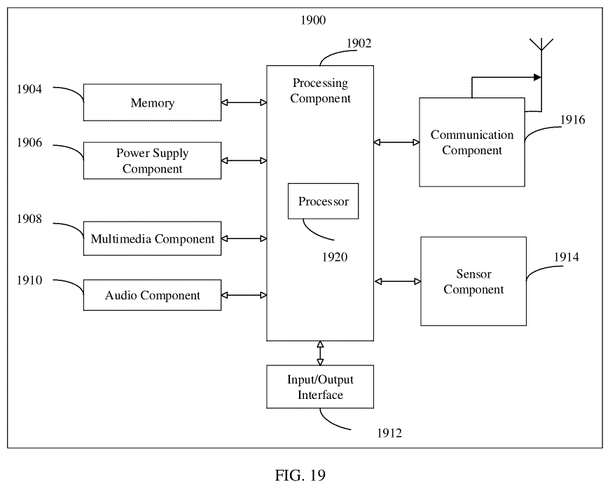

FIG. 19 is a block diagram of UE 1900 provided by an example of the present disclosure. For example, the UE 1900 may be a mobile phone, a computer, a digital broadcasting terminal, a messaging device, a game console, a tablet device, a medical device, a fitness device, a personal digital assistant, and the like.

In referring to FIG. 19, the UE 1900 may include at least one of the following components: a processing component 1902, a memory 1904, a power supply component 1906, a multimedia component 1908, an audio component 1910, an input/output (I/O) interface 1912, a sensor component 1914, and a communication component 1916.

The processing component 1902 generally controls the overall operations of the UE 1900 such as operations associated with display, phone calls, data communications, camera operations, and recording operations. The processing component 1902 may include at least one processor 1920 to execute instructions to complete all or a part of the steps of the above methods. In addition, the processing component 1902 may include at least one module which facilitate the interaction between the processing component 1902 and other components. As an example, the processing component 1902 may include a multimedia module to facilitate the interaction between the multimedia component 1908 and the processing component 1902.

The memory 1904 is configured to store various types of data to support the operations of the UE 1900. Examples of such data include instructions for any application or method operated on the UE 1900, contact data, phonebook data, messages, pictures, videos, and the like. The memory 1904 may be implemented by any type of volatile or non-volatile storage device or a combination thereof, such as a static random access memory (SRAM), an electrically erasable programmable read-only memory (EEPROM), an erasable and programmable read-only memory (EPROM), a programmable read-only memory (PROM), a read-only memory (ROM), a magnetic memory, a flash memory, a magnetic disk or an optical disk.

The power supply component 1906 provides power for various components of the UE 1900. The power supply component 1906 may include a power management system, at least one power supply, and other components associated with generating, managing, and distributing power for the UE 1900.

The multimedia component 1908 includes a screen providing an output interface between the UE 1900 and a user. In some examples, the screen may include a liquid crystal display (LCD) and a touch panel (TP). If the screen includes the TP, the screen may be implemented as a touch screen to receive input signals from the user. The TP may include at least one touch sensor to sense touches, swipes, and gestures on the TP. The touch sensors may not only sense a boundary of a touch or swipe, but also sense a lasting time and a pressure associated with the touch or swipe. In some examples, the multimedia component 1908 includes a front camera and/or a rear camera. The front camera and/or rear camera may receive external multimedia data when the UE 1900 is in an operating mode, such as a photographing mode or a video mode. Each of the front and rear cameras can be a fixed optical lens system or have focal length and optical zoom capability.

The audio component 1910 is configured to output and/or input audio signals. For example, the audio component 1910 includes a microphone (MIC) that is configured to receive an external audio signal when the UE 1900 is in an operating mode, such as a call mode, a recording mode, and a voice recognition mode. The received audio signal may be further stored in the memory 1904 or transmitted via the communication component 1916. In some examples, the audio component 1910 also includes a speaker for outputting audio signals.

The I/O interface 1912 provides an interface between the processing component 1902 and a peripheral interface module. The above peripheral interface module may be a keyboard, a click wheel, buttons, or the like. These buttons may include but not limited to a home button, a volume button, a start button and a lock button.

The sensor component 1914 includes at least one sensor to provide the UE 1900 with status assessments in various aspects. For example, the sensor component 1914 may detect an open/closed state of the device 1900 and a relative positioning of components such as the display and keypad of the UE 1900, and the sensor component 1914 may also detect a change in position of the UE 1900 or a component of the UE 1900, the presence or absence of the target object contacting with the UE 1900, orientation or acceleration/deceleration of the UE 1900, and temperature change of the UE 1900. The sensor component 1914 may include a proximity sensor configured to detect the presence of nearby objects in the absence of any physical contact. The sensor component 1914 may further include an optical sensor, such as a complementary metal-oxide-semiconductor (CMOS) or charged coupled device (CCD) image sensor which is used in imaging applications. In some examples, the sensor component 1914 may also include an acceleration sensor, a gyro sensor, a magnetic sensor, a pressure sensor, or a temperature sensor.

The communication component 1916 is configured to facilitate wired or wireless communication between the UE 1900 and other devices. The UE 1900 may access a wireless network based on a communication standard, such as Wi-Fi, 2G, 3G, 4G, 5G, 6G or a combination thereof. In an example, the communication component 1916 receives broadcast signals or broadcast related information from an external broadcast management system via a broadcast channel. In an example, the communication component 1916 also includes a near field communication (NFC) module to facilitate short-range communication. For example, the NFC module may be implemented based on a radio frequency identification (RFID) technology, an infrared data association (IrDA) technology, an ultra-wideband (UWB) technology, a Bluetooth® (BT) technology and other technologies.

In an example, the UE 1900 may be implemented by at least one application specific integrated circuit (ASIC), digital signal processor (DSP), digital signal processing device (DSPD), programmable logic device (PLD), field programmable gate array (FPGA), controller, microcontroller, microprocessor, or other electronic components for performing the above methods.

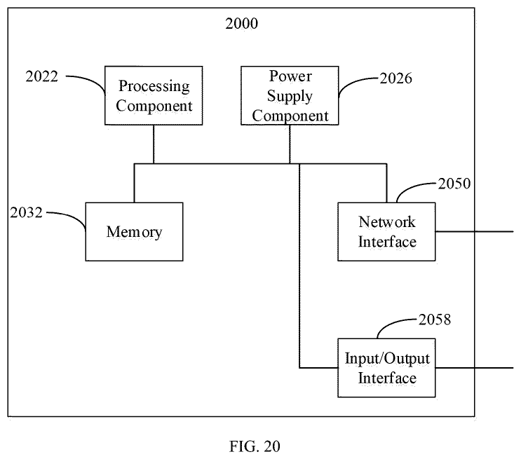

FIG. 20 is a block diagram of a network-side device 2000 provided by an example of the present disclosure. For example, the network-side device 2000 may be provided as a device on a network side. In referring to FIG. 20, the network-side device 2000 includes a processing component 2022 which further includes at least one processor, and memory resources which represented by a memory 2032 and is used to store instructions that may be executed by the processing component 2022, e.g., application programs. The application programs stored in the memory 2032 may include one or more modules, each of which corresponds to a set of instructions. In addition, the processing component 2022 is configured to execute instructions to perform any one of the aforementioned methods applicable to the network-side device, for example, the method illustrated in FIG. 9.

The network-side device 2000 may also include a power supply component 2026 which is configured to perform power management for the network-side device 2000, a wired or wireless network interface 2050 which is configured to connect the network-side device 2000 to a network, and an input/output (I/O) interface 2058. The network-side device 2000 may operate based on an operating system stored in the memory 2032, such as Windows Server™, Mac OS X™, Unix™, Linux™, FreeBSD™ or the like.

In the examples provided by the present disclosure, the methods provided in the examples of the present disclosure are introduced from the perspectives of the network-side device and the UE respectively. In order to realize the various functions in the methods provided by the foregoing examples of the present disclosure, the network-side device and the UE may include hardware structures and software modules, and implement the above various functions in the form of the hardware structures, the software modules, or the hardware structures plus the software modules. A certain function among the above various functions may be implemented in the form of a hardware structure, a software module, or a hardware structure plus a software module.

In the examples provided by the present disclosure, the methods provided in the examples of the present disclosure are introduced from the perspectives of the network-side device and the UE respectively. In order to realize the various functions in the methods provided by the foregoing examples of the present disclosure, the network-side device and the UE may include hardware structures and software modules, and implement the above various functions in the form of the hardware structures, the software modules, or the hardware structures plus the software modules. A certain function among the above various functions may be implemented in the form of a hardware structure, a software module, or a hardware structure plus a software module.

A communication device is provided by an example of the present disclosure. The communication device may include a transceiver module and a processing module. The transceiver module may include a transmitting module and/or a receiving module. The sending module is configured to implement a sending function, the receiving module is configured to implement a receiving function, and the transceiver module may implement the sending function and/or the receiving function.

The communication device may be a terminal device (such as the terminal device in the foregoing method examples), or a device in the terminal device, or a device that is used by matching the terminal device. Alternatively, the communication device may be a network device, or a device in the network device, or a device that is used by matching the network device.

Another communication device is provided by an example of the present disclosure. The communication device may be a network device, or a terminal device (such as the terminal device in the foregoing method examples). Alternatively, the communication device may be a chip, a chip system or a processor that supports the network device to implement the above methods, or a chip, a chip system or a processor that supports the terminal device to implement the above methods. The device may be configured to implement the methods described in the foregoing method examples, whose details may make reference to the descriptions in the foregoing method examples.

The communications device may include one or more processors. The processor may be a general processor or a dedicated processor or the like. For example, it may be a baseband processor or a central processing unit. The baseband processor may be configured to process communication protocols and communication data, and the central processor may be configured to control a communication device (such as a network-side device, a baseband chip, a terminal device, a terminal device chip, a distributed unit (DU) or a centralized unit (CU), etc.), execute a computer program and process data of the computer program.

Alternatively or additionally, the communication device may further include one or more memories, on which a computer program may be stored, and the one or more processors execute the computer program, so as to enable the communication device to execute the methods described in the foregoing method examples. Alternatively or additionally, data may further be stored in the one or more memories. The communication device and the one or more memories may be set separately or integrated together.

Alternatively or additionally, the communication device may further include a transceiver and an antenna. The transceiver may be referred to as a transceiver unit, a transceiver, or a transceiver circuit, etc., and is configured to implement a transceiver function. The transceiver may include a receiver and a transmitter. The receiver may be called a receiving machine or a receiving circuit for implementing a receiving function, and the transmitter may be called a transmitting machine or a transmitting circuit for implementing a transmitting function.

Alternatively or additionally, the communication device may further include one or more interface circuits. The interface circuit is configured to receive and transmit code instructions to the one or more processors. The one or more processors execute the code instructions to enable the communication device to perform the methods described in the foregoing method examples.

For the case where the communication device is a terminal device (such as the terminal device in the foregoing method examples), the one or more processors are configured to perform the method illustrated in any one of FIG. 1-FIG. 8b.

For the case where the communication device is a network device, the transceiver is configured to perform the method illustrated in any one of FIG. 9-FIG. 16b.

In an implementation, the transceiver for implementing the receiving and transmitting function may be included in the processor. For example, the transceiver may be a transceiver circuit, or an interface, or an interface circuit. The transceiver circuit, interface or interface circuit for implementing the receiving and transmitting function may be separated or integrated together. The above transceiver circuit, interface or interface circuit may be configured to read and write code/data. Alternatively, the above transceiver circuit, interface or interface circuit may be configured to transmit or transfer signals.

In an implementation, the one or more processors may store a computer program, and the computer program runs on the one or more processors to enable the communication device to perform the methods described in the foregoing method examples. The computer program may be solidified in the one or more processors, in which case the one or more processors may be implemented by hardware.

In an implementation, the communication device may include a circuit, and the circuit may implement the function of transmitting, receiving or communicating in the foregoing method examples. The one or more processors and transceivers described in the present disclosure may be implemented on an integrated circuit (IC), an analog IC, a radio frequency integrated circuit (RFIC), a mixed-signal IC, an application specific integrated circuit (ASIC), a printed circuit board (PCB), an electronic device, etc. The one or more processors and transceivers may also be fabricated with various IC processing technologies such as complementary metal oxide semiconductor (CMOS), nMetal-oxide-semiconductor (NMOS), positive channel metal oxide semiconductor (PMOS), bipolar junction transistor (BJT), bipolar CMOS (BiCMOS), silicon germanium (SiGe), gallium arsenide (GaAs), etc.

The communication device described in the above examples may be a network device or a terminal device (such as the terminal device in the foregoing method examples). However, the communication device described in the present disclosure is not limited by such a range, and the structure of the communication device may not be limited. The communication device may be a stand-alone device or may be a part of a larger device. For example, the communication device may be:
(1) stand-alone ICs, chips, or chip systems or subsystems;
(2) a set of one or more ICs, which may alternatively or additionally include storage components for storing data and computer programs;
(3) ASIC, such as a modem;
(4) modules that may be embedded in other devices;
(5) a receiver, a terminal device, an intelligent terminal device, a cellular phone, a wireless device, a handset, a mobile unit, a vehicle device, a network device, a cloud device, an artificial intelligence device, etc.;
(6) others and so on.

For the case where the communications device may be the chip or the chip system, the chip includes processors and interfaces. The number of the processors may be one or more, and the number of the interfaces may be more than one.

Alternatively and additionally, the chip also includes a memory for storing necessary computer programs and data.

Those skilled in the art may also understand that various illustrative logical blocks and steps presented in the examples of the present disclosure may be implemented through electronic hardware, computer software, or a combination of the both. Whether such functions are implemented through the hardware or the software depends on specific applications and overall system design requirements. Those skilled in the art may use various approaches to implement the described function for each specific application. However, such implementation should not be understood as exceeding the protection scope of the examples of the present disclosure.

An example of the present disclosure also provides an information configuration system. The system includes the communication device as a terminal device (such as the terminal device in the foregoing method examples) and the communication device as a network device in the above examples.

The present disclosure also provides a readable storage medium on which instructions are stored. The instructions, when executed by a computer, implement the functions of any one of the foregoing method examples.

The present disclosure also provides a computer program product, which implements the functions of any one of the foregoing method examples when being executed by a computer.

In view of the above, in the information configuration methods, apparatuses, devices, and storage media provided by the examples of the present disclosure, the UE determines at least one available measurement gap configuration and/or an association between each available measurement gap configuration and one or more specific to-be-measured parameters for indication based on a configuration of a network-side device, and subsequently a corresponding cell or frequency point can be measured based on the association and the at least one available measurement gap configuration. Specifically, in the examples of the present disclosure, the UE determines the at least one available measurement gap configuration based on at least one measurement gap offset configured by the network-side device. It can be seen that in the examples of the present disclosure, a plurality of available measurement gap configurations can be obtained by configuring only a plurality of measurement gap offsets, resulting in low signaling overheads. Meanwhile, lager number of available measurement gap configurations can be obtained since there is no limit to the number of the configured measurement gap offsets, which can be suitable for measuring a plurality of different to-be-measured cells or frequency points.

In the above examples, it can be implemented in whole or in part by software, hardware, firmware, or any combination thereof. When implemented in software, it can be implemented in whole or in part in the form of a computer program product. The computer program product includes one or more computer programs. When the computer programs are loaded and executed on a computer, the processes or function according to the examples of the present disclosure are generated in whole or in part. The computer may be a general-purpose computer, a dedicated computer, a computer network, or another programmable device. The computer programs may be stored in a computer-readable storage medium or transmitted from one computer-readable storage medium to another computer-readable storage medium, for example, the computer programs may be transmitted from a website site, a computer, a server or a data center via wire (for example, coaxial cable, optical fiber, digital subscriber line (DSL)) or wireless (for example, infrared, wireless, microwave, etc.) to another website, another computer, another server, or another data center. The computer-readable storage medium may be any available medium that can be accessed by a computer or a data storage device such as a server and a data center integrating one or more available media. The available medium may be a magnetic medium (for example, a floppy disk, a hard disk, a magnetic tape), an optical medium (for example, a high-density digital video disc (DVD)), or a semiconductor medium (for example, a solid state disk (SSD)), etc.

Those of ordinary skill in the art may understand that the first, second, and other numbers involved in the present disclosure are only for convenience of description, instead of limiting the scope of the examples of the present disclosure or indicating a sequential order.

“At least one” in the present disclosure may also be described as “one or more”. The “more” may refer to two, three, four or more, which is not limited by the present disclosure. In the examples of the present disclosure, for a technical character, its technical factors are distinguished by “first,” “second,” “third,” “A,” “B,” “C,” and “D,” etc. There is no any sequential order or size order between the technical features described by the “first,” “second,” “third,” “A,” “B,” “C” and “D.”

Other implementations of the present disclosure will be readily apparent to those skilled in the art after implementing the disclosure by referring to the specification. The present disclosure is intended to cover any variations, uses, or adaptations of the present disclosure that are in accordance with the general principles thereof and include common general knowledge or conventional technical means in the art that are not disclosed in the present disclosure. The description and the examples are only illustrative, and the scope and spirit of the present disclosure are to be indicated by appended claims.

It should be understood that the present disclosure is not limited to the above-described accurate structures illustrated in the drawings, and various modifications and changes can be made to the present disclosure without departing from the scope thereof. The scope of the present disclosure is to be limited only by the appended claims.

1. An information configuration method, performed by user equipment (UE), comprising:
determining, based on a configuration of a network-side device, at least one of at least one available measurement gap configuration or an association between each available measurement gap configuration and one or more specific to-be-measured parameters for indication.

2. The method according to claim 1, wherein the one or more specific to-be-measured parameters comprise at least one of:
a measurement object;
a to-be-measured frequency;
a to-be-measured cell;
a to-be-measured satellite; or
a synchronization signal block measurement timing configuration (SMTC) configuration.

3. The method according to claim 1, wherein determining, based on the configuration of the network-side device, at least one of the at least one available measurement gap configuration or the association between each available measurement gap configuration and the one or more specific to-be-measured parameters for indication comprises:
determining, based on the configuration of the network-side device, the at least one available measurement gap configuration and the association between each available measurement gap configuration and the one or more specific to-be-measured parameters; or
determining the at least one available measurement gap configuration based on the configuration of the network-side device.

4. The method according to claim 3, wherein determining, based on the configuration of the network-side device, the at least one available measurement gap configuration and the association between each available measurement gap configuration and the one or more specific to-be-measured parameters comprises one of:
acquiring first configuration information sent by the network-side device, wherein the first configuration information comprises at least one measurement gap offset and the one or more specific to-be-measured parameters associated with each measurement gap offset; and determining, based on a previous measurement gap configuration and the first configuration information, the at least one available measurement gap configuration and the association between each available measurement gap configuration and the one or more specific to-be-measured parameters, wherein the previous measurement gap configuration comprises one or more of a measurement gap length, a measurement gap period, and a measurement gap timing advance;
acquiring a configuration corresponding to the one or more specific to-be-measured parameters and either at least one measurement gap offset or at least one measurement gap offset identifier sent by the network-side device, wherein the configuration corresponding to the one or more specific to-be-measured parameters comprises an association between the one or more specific to-be-measured parameters and either the at least one measurement gap offset or the at least one measurement gap offset identifier; and determining the at least one available measurement gap configuration and the association between each available measurement gap configuration and the one or more specific to-be-measured parameters based on a previous measurement gap configuration, either the at least one measurement gap offset or the at least one measurement gap offset identifier, and the configuration corresponding to the one or more specific to-be-measured parameters, wherein the previous measurement gap configuration comprises one or more of a measurement gap length, a measurement gap period, and a measurement gap timing advance; or
acquiring second configuration information sent by the network-side device, wherein the second configuration information is configured to configure a measurement gap; and determining, based on a previous measurement gap configuration and the second configuration information, the at least one available measurement gap configuration and the association between each available measurement gap configuration and the one or more specific to-be-measured parameters, wherein the previous measurement gap configuration comprises one or more of a measurement gap length, a measurement gap period, and a measurement gap timing advance.

5. (canceled)

6. (canceled)

7. The method according to claim 4, wherein the second configuration information comprises at least one of:
a first offset list of the measurement gap, wherein the first offset list comprises at least one measurement gap offset;
at least one measurement gap offset identifier for indicating the at least one measurement gap offset; or
a second offset list of the measurement gap, wherein the second offset list comprises at least one measurement gap offset and at least one measurement gap offset identifier for indicating the at least one measurement gap offset;
an association between the measurement gap offset and the one or more specific to-be-measured parameters;
an association between the measurement gap offset identifier and the one or more specific to-be-measured parameters;
an association between the measurement gap offset and one or more identifiers of the one or more specific to-be-measured parameters; or
an association between the measurement gap offset identifier and one or more identifiers of the one or more specific to-be-measured parameters.

8. (canceled)

9. The method according to claim 3, wherein determining the at least one available configuration of the measurement gap based on the configuration of the network-side device comprises:
receiving third configuration information sent by the network-side device, wherein the third configuration information is configured to configure a measurement gap; and
determining the at least one available measurement gap configuration based on the third configuration information.

10. The method according to claim 9, wherein the third configuration information comprises at least one of:
a measurement gap length;
a measurement gap period;
a measurement gap timing advance;
a first offset list of the measurement gap, wherein the first offset list comprises at least one measurement gap offset;
at least one measurement gap offset identifier for indicating the at least one measurement gap offset; or
a second offset list of the measurement gap, wherein the second offset list comprises at least one measurement gap offset and at least one measurement gap offset identifier for indicating the at least one measurement gap offset.

11. (canceled)

12. The method according to claim 1, further comprising:
acquiring an update message sent by the network-side device; and
updating the available measurement gap configuration based on the update message.

13. The method according to claim 12,
wherein the update message comprises one or more measurement gap offset identifiers and one or more measurement gap offsets; and updating the available measurement gap configuration based on the update message comprises:
determining whether each measurement gap offset identifier comprised in the update message exists;
updating a measurement gap configuration corresponding to the measurement gap offset identifier comprised in the update message based on a corresponding measurement gap offset comprised in the update message, wherein the measurement gap offset identifier comprised in the update message exists; and
adding a new available measurement gap configuration based on the measurement gap offset and the measurement gap offset identifier comprised in the update message, wherein the measurement gap offset identifier comprised in the update message does not exist; or
wherein the update message comprises one or more measurement gap offset identifiers and a deletion indication, and updating the available measurement gap configuration based on the update message comprises:
deleting the available measurement gap configuration corresponding to the measurement gap offset identifier comprised in the update message based on the deletion indication.

14. (canceled)

15. An information configuration method, performed by a network-side device, comprising:
configuring for user equipment (UE) at least one of at least one available measurement gap configuration or an association between each available measurement gap configuration and one or more specific to-be-measured parameters for indication.

16. The method according to claim 15, wherein the one or more specific to-be-measured parameters comprise at least one of:
a measurement object;
a to-be-measured frequency;
a to-be-measured cell;
a to-be-measured satellite; or
a synchronization signal block measurement timing configuration (SMTC) configuration.

17. The method according to claim 15, wherein configuring for the UE at least one of the at least one available measurement gap configuration or the association between each available measurement gap configuration and the one or more specific to-be-measured parameters for indication comprises:
configuring for the UE the at least one available measurement gap configuration and the association between each available measurement gap configuration and the one or more specific to-be-measured parameters; or
configuring for the UE the at least one available measurement gap configuration.

18. The method according to claim 17, wherein determining for the UE the at least one available measurement gap configuration and the association between each available measurement gap configuration and the one or more specific to-be-measured parameters comprises one of:
sending first configuration information to the UE, wherein the first configuration information comprises at least one measurement gap offset and the one or more specific to-be-measured parameters associated with each measurement gap offset;
sending a configuration corresponding to the one or more specific to-be-measured parameters and either at least one measurement gap offset or at least one measurement gap offset identifier to the UE, wherein the configuration corresponding to the one or more specific to-be-measured parameters comprises an association between the one or more specific to-be-measured parameters and either the measurement gap offset or the measurement gap offset identifier; or
sending second configuration information to the UE, wherein the second configuration information is configured to configure a measurement gap.

19. (canceled)

20. (canceled)

21. The method according to claim 18, wherein the second configuration information comprises at least one of:
a first offset list of the measurement gap, wherein the first offset list comprises at least one measurement gap offset;
at least one measurement gap offset identifier for indicating the at least one measurement gap offset; or
a second offset list of the measurement gap, wherein the second offset list comprises at least one measurement gap offset and at least one measurement gap offset identifier for indicating the at least one measurement gap offset;
an association between the measurement gap offset and the one or more specific to-be-measured parameters;
an association between the measurement gap offset identifier and the one or more specific to-be-measured parameters;
an association between the measurement gap offset and one or more identifiers of the one or more specific to-be-measured parameters; or
an association between the measurement gap offset identifier and one or more identifiers of the one or more specific to-be-measured parameters.

22. (canceled)

23. The method according to claim 17, wherein configuring for the UE the at least one available measurement gap configuration comprises:
sending third configuration information to the UE, wherein the third configuration information is configured to configure a measurement gap.

24. The method according to claim 23, wherein the third configuration information comprises at least one of:
a measurement gap length;
a measurement gap period;
a measurement gap timing advance;
a first offset list of the measurement gap, wherein the first offset list comprises at least one measurement gap offset;
at least one measurement gap offset identifier for indicating the at least one measurement gap offset; or
a second offset list of the measurement gap, wherein the second offset list comprises at least one measurement gap offset and at least one measurement gap offset identifier for indicating the at least one measurement gap offset.

25. (canceled)

26. The method according to claim 15, further comprising:
sending an update message to the UE.

27. The method according to claim 26, wherein the update message comprises:
one or more measurement gap offset identifiers and one or more measurement gap offsets; or
one or more measurement gap offset identifiers and a deletion indication.

28.-30. (canceled)

31. A communication device, comprising:
a processor, and
a memory storing a computer program executable by the processor;
wherein the processor is configured to:
determine, based on a configuration of a network-side device, at least one of at least one available measurement gap configuration or an association between each available measurement gap configuration and one or more specific to-be-measured parameters for indication.

32. A communication device, comprising:
a processor, and
a memory storing a computer program executable by the processor;
wherein the processor is configured to perform the method according to claim 15.

33.-36. (canceled)
